(19) United States
(12) Patent Application Publication
(10) Pub. No.: US 2026/0317103 A1
(43) Pub. Date: Oct. 15, 2026

(54) LONG OBJECT PROCESSING APPARATUS

(71) Applicant: JTEKT CORPORATION, Kariya-shi (JP)

(72) Inventors: Yosuke MAEDA, Shinagawa-ku (JP); Tomohiko WATABE, Nagoya-shi (JP); Kazuhisa MOTOTANI, Anjo-shi (JP); Hiroshi OKA, Chiryu-shi (JP); Kuni CHIN, Owariasahi-shi (JP); Koji KITO, Toyota-shi (JP)

(73) Assignee: JTEKT CORPORATION, Kariya-shi (JP)

(21) Appl. No.: 19/481,433

(22) PCT Filed: May 11, 2023
(86) PCT No.: PCT/JP2023/017727

§ 371 Date: Nov. 4, 2025

(51) Int. Cl. B65H 18/08; B05C 9/12; B05C 11/11; B05C 13/00; B05C 21/00; B65H 23/195; B65H 35/00; H01M 4/04

(52) U.S. Cl. CPC B65H 18/08; B05C 9/12; B05C 11/11; B05C 13/00; B05C 21/00; B65H 23/195; B65H 35/0066; B65H 35/0093; H01M 4/0404; B65H 2301/5162; B65H 2301/5163; B65H 2404/20; B65H 2408/23; B65H 2553/42; B65H 2553/51; B65H 2701/19

(57) ABSTRACT

A long object processing apparatus includes: a feeding device; a processing device; a control device that controls operations of the feeding device and the processing device, causes the processing device to continuously process the long material in the feeding direction, and causes the processing device to process the long material while changing a plurality of different processing conditions over time during continuous processing; a reference position detection device that detects a reference position of the long material; a feeding amount detection device that detects a feeding amount of the long material from the reference position; and a storage device that stores the processing conditions acquired from the control device for a long product manufactured by processing performed by the processing device in association with the feeding amount from the reference position that is acquired from the feeding amount detection device in terms of the feeding amount.

### TECHNICAL FIELD

The present disclosure relates to a long object processing apparatus.

### BACKGROUND ART

Conventionally, an apparatus described in Patent Document 1 is known as a long object processing apparatus for processing a long material to manufacture a long product. This long object processing apparatus is an electrode manufacturing apparatus that manufactures an electrode in which an active material layer is formed on at least one surface of a sheet-shaped metal foil.

The electrode manufacturing apparatus includes a kneading unit and a coating and drying unit. The kneading unit includes a container and a screw. In the kneading unit, an active material, a conductive assistant, a binder, a solvent, etc. are placed in the container and kneaded by the screw to produce a coating material such as a slurry.

In the coating and drying unit, the coating material is applied to the metal foil and then dried. The coating and drying unit includes an unwinding unit, a coating unit, a drying unit, and a winding unit. The unwinding unit includes an unwinding roll around which the metal foil is wound. The metal foil is sent out from the unwinding roll. The metal foil is transported from the unwinding unit to the winding unit, and is wound up around a winding roll disposed in the winding unit. The coating unit and the drying unit are disposed between the unwinding unit and the winding unit.

The coating unit includes a coating head having an ejection port. The coating head has the ejection port. The coating head ejects the coating material supplied by a pump from the ejection port. The coating head ejects the coating material onto the surface of the metal foil. Thus, the coating material is applied to one surface of the metal foil.

The drying unit includes a drying chamber and a plurality of hot air generators. The drying chamber is disposed to surround the metal foil being transported. The hot air generators are disposed in the drying chamber. The hot air generators blow air heated by heaters toward the metal foil to which the coating material is applied. Thus, the solvent contained in the coating material evaporates, and the active material etc. are bound to the metal foil by the binder, thereby forming an active material layer on the metal foil.

In the kneading unit, a plurality of containers is prepared, and the coating material is prepared in each container. The coating material is transported to the coating unit by the pump from one of the plurality of containers in which the coating material is prepared. When the remaining amount of the coating material in the one container decreases and falls below a predetermined remaining amount, the coating material is supplied to the coating unit from another one of the plurality of containers. Then, this operation is repeated.

### RELATED ART DOCUMENTS

### Patent Documents

Patent Document 1: Japanese Unexamined Patent Application Publication No. 2022-102225 (JP 2022-102225 A)

### SUMMARY OF THE INVENTION

### Problem to be Solved by the Invention

When the coating materials prepared in different containers are applied sequentially to the metal foil during the manufacturing of a long material such as the above electrode sheet, there may be unclearness about the container for the preparation of the coating material for a specific part of the active material layer formed on the electrode sheet. Even when the coating material is prepared in one agitation tank, stored separately in different containers, and then applied sequentially to the metal foil, there may be unclearness about the container that stores the coating material for a specific part of the active material layer formed on the electrode sheet. From the viewpoint of quality control, it is desirable that the long product manufactured by processing be stored in association with a plurality of processing conditions.

In the case of a long material such as the electrode sheet, for example, when pressing conditions or drying conditions for the coating material applied to the metal foil change over time, there may be unclearness about the pressing conditions or the drying conditions of processing of a specific part of the active material layer formed on the electrode sheet. Even in such a case, from the viewpoint of quality control, it is desirable that the long product manufactured by processing be stored in association with the plurality of processing conditions.

The present disclosure has been made in view of the above background, and provides a long object processing apparatus that processes a long material while changing a plurality of different processing conditions over time, and that can store a long product manufactured by processing in association with the processing conditions.

### Means for Solving the Problem

One aspect of the present disclosure relates to a long object processing apparatus including: a feeding device or a belt conveyor that feeds a long material in a feeding direction; a processing device that processes the long material fed by the feeding device or the belt conveyor; a control device that controls operations of the feeding device or the belt conveyor and the processing device, causes the processing device to continuously process the long material in the feeding direction, and causes the processing device to process the long material while changing a plurality of different processing conditions over time during continuous processing; a reference position detection device that detects a reference position that is a reference for the long material or a reference for a starting point of the belt conveyor; a feeding amount detection device that detects a feeding amount of the long material from the reference position in the feeding direction in terms of a unit period or in terms of a unit feeding amount; and a storage device that stores the processing conditions acquired from the control device for a long product manufactured by processing performed by the processing device in association with the feeding amount from the reference position that is acquired from the feeding amount detection device in terms of the unit period or in terms of the unit feeding amount, in which: the processing device is a coating device (30A) that applies a coating material to the long material as processing of the long material; the processing device includes a plurality of containers (31A, 32A, 33A) that contains the coating material, and forms a composite layer on a metal foil while switching the plurality of containers; the processing conditions are related to which container out of the plurality of containers contains the applied coating material; and the storage device stores information as to which container out of the plurality of containers contains the applied coating material in association with the feeding amount from the reference position that is acquired from the feeding amount detection device. Another aspect of the present disclosure relates to a long object processing apparatus including: a feeding device or a belt conveyor that feeds a long material in a feeding direction; a processing device that processes the long material fed by the feeding device or the belt conveyor; a control device that controls operations of the feeding device or the belt conveyor and the processing device, causes the processing device to continuously process the long material in the feeding direction, and causes the processing device to process the long material while changing a plurality of different processing conditions over time during continuous processing; a reference position detection device that detects a reference position that is a reference for the long material or a reference for a starting point of the belt conveyor; a feeding amount detection device that detects a feeding amount of the long material from the reference position in the feeding direction in terms of a unit period or in terms of a unit feeding amount; and a storage device that stores the processing conditions acquired from the control device for a long product manufactured by processing performed by the processing device in association with the feeding amount from the reference position that is acquired from the feeding amount detection device in terms of the unit period or in terms of the unit feeding amount, in which: a plurality of the processing devices is provided; the processing conditions are set for each of the plurality of the processing devices; a reference distance that is a distance between the reference position and each of the plurality of the processing devices is set for each of the plurality of the processing devices; the storage device stores the reference distance for each of the plurality of the processing devices; and the control device converts the processing conditions stored in the storage device in association with the feeding amount from the reference position that is acquired from the feeding amount detection device in terms of the unit period or in terms of the unit feeding amount into processing conditions associated with each position on the long material by subtracting the reference distance from the feeding amount, and causes the storage device to store the converted processing conditions. Still another aspect of the present disclosure relates to a long object processing apparatus including: a feeding device or a belt conveyor that feeds a long material in a feeding direction; a processing device that processes the long material fed by the feeding device or the belt conveyor; a control device that controls operations of the feeding device or the belt conveyor and the processing device, causes the processing device to continuously process the long material in the feeding direction, and causes the processing device to process the long material while changing a plurality of different processing conditions over time during continuous processing; a reference position detection device that detects a reference position that is a reference for the long material or a reference for a starting point of the belt conveyor; a feeding amount detection device that detects a feeding amount of the long material from the reference position in the feeding direction in terms of a unit period or in terms of a unit feeding amount; a storage device that stores the processing conditions acquired from the control device for a long product manufactured by processing performed by the processing device in association with the feeding amount from the reference position that is acquired from the feeding amount detection device in terms of the unit period or in terms of the unit feeding amount; a cutting device that cuts the long product to a predetermined length dimension; and a manufacturing number providing device that provides a manufacturing number to the long product or a packaging material that packages the long product, in which the storage device stores, for a cut object cut out by the cutting device, the feeding amount from the reference position in a state of the long product before the cut object is cut out in association with the manufacturing number.

The reference signs in parentheses in the claims indicate the corresponding relationships with the specific means described in the embodiments described later, and are not intended to limit the technical scope of the present disclosure.

### Effects of the Invention

According to the one aspect, the other aspect, and the still other aspect of the present disclosure, it is possible to store the long product manufactured by processing in association with the plurality of different processing conditions in the long object processing apparatus that processes the long material while changing the processing conditions over time. Therefore, it is possible to clearly grasp the association between the portion where a defect has occurred in the long product and the processing conditions, thereby improving the level of the quality control of the long product.

### BRIEF DESCRIPTION OF THE DRAWINGS

FIG. 1 is a block diagram showing an electrode manufacturing apparatus according to a first embodiment.

FIG. 2 is a block diagram showing a first manufacturing apparatus according to the first embodiment.

FIG. 3 is a partially enlarged plan view showing a metal foil according to a modification of the first embodiment.

FIG. 4 is a block diagram showing a second manufacturing apparatus according to the first embodiment.

FIG. 5 is a plan view showing an electrode manufactured by the electrode manufacturing apparatus according to the first embodiment.

FIG. 6 is a plan view showing an electrode sheet A manufactured by the electrode manufacturing apparatus according to the first embodiment.

FIG. 7 is a plan view showing an electrode sheet B manufactured by the electrode manufacturing apparatus according to the first embodiment.

FIG. 8 is a plan view showing an electrode sheet C manufactured by the electrode manufacturing apparatus according to the first embodiment.

FIG. 9 is a plan view showing an electrode sheet D manufactured by the electrode manufacturing apparatus according to the first embodiment.

FIG. 10 is a plan view showing an electrode sheet E manufactured by the electrode manufacturing apparatus according to the first embodiment.

FIG. 11 is a plan view showing an electrode sheet F manufactured by the electrode manufacturing apparatus according to the first embodiment.

FIG. 12 is a flowchart showing an operation of the electrode manufacturing apparatus according to the first embodiment.

FIG. 13 is a flowchart showing a feeding process according to the first embodiment.

FIG. 14 is a flowchart showing a coating process according to the first embodiment.

FIG. 15 is a flowchart showing a first container process according to the first embodiment.

FIG. 16 is a flowchart showing a second container process according to the first embodiment.

FIG. 17 is a flowchart showing a third container process according to the first embodiment.

FIG. 18 is a diagram showing part of Table 1 according to the first embodiment.

FIG. 19 is a diagram showing part of Table 2 according to the first embodiment.

FIG. 20 is a schematic diagram showing a first display screen according to the first embodiment.

FIG. 21 is a schematic diagram showing a second display screen according to the first embodiment.

FIG. 22 is a flowchart showing a process of inputting information related to an inscription according to the first embodiment.

FIG. 23 is a schematic diagram showing a third display screen according to the first embodiment.

FIG. 24 is a block diagram showing a food production apparatus according to a second embodiment.

FIG. 25 is a block diagram showing a food production apparatus according to a third embodiment.

### MODES FOR CARRYING OUT THE INVENTION

### First Embodiment

### 1. Long Object Processing Apparatus, Long Material, and Long Product

### 1-1. Long Object Processing Apparatus

The long object processing apparatus according to the present disclosure processes a long material to produce a long product. The long material and the long product are formed in a shape that is long in the longitudinal direction. The processing to be performed on the long material by the long object processing apparatus is not particularly limited. Examples thereof include application of a coating material to the long material, rolling of the coating material, and drying of the coating material. Other examples include machining such as cutting on the long material, heat treatment such as heating, drying, cooling, or baking, and processing such as bonding or printing.

### 1-2. Long Material

The long material may have any shape such as a shape of a foil, a sheet, a plate, or a bar as appropriate. The long material may have a uniform shape in the longitudinal direction, or may have a shape that varies in the longitudinal direction. For example, part of the shape in the longitudinal direction may be a plate shape, and the other part of the shape may be a bar shape.

The material constituting the long material is not particularly limited, and any material such as metal, resin, wood, ceramic, glass, cloth, or paper can be selected as appropriate. The material constituting the long material may be, for example, food dough, and any dough can be selected as appropriate, as typified by dough for noodles such as soba, udon, or ramen, dough for sweets such as cookies, biscuits, or cakes, or bread dough.

### 1-3. Long Product

The long product is a product obtained by processing the above long material. Examples of the processing on the long material include application of a coating material, rolling of the coating material, and drying of the coating material. Any processing such as cutting or bonding can be performed on the long material. The long product is not particularly limited. Examples thereof include battery electrodes and food dough.

### 2. Electrode Manufacturing Apparatus 10

### 2-1. Overview of Electrode Manufacturing Apparatus 10

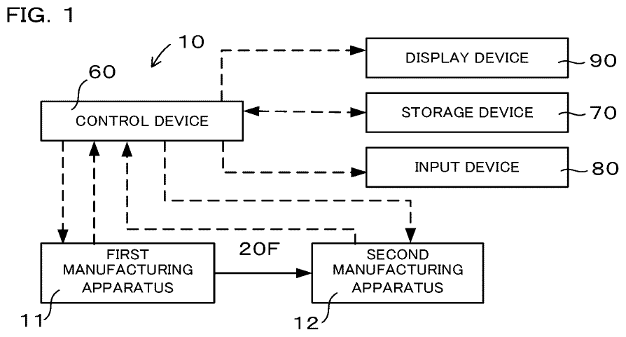

A first embodiment in which the present disclosure is applied to an electrode manufacturing apparatus 10 (example of the long object processing apparatus) will be described with reference to FIG. 1. The electrode manufacturing apparatus 10 of the present embodiment includes a control device 60, a storage device 70, an input device 80, a display device 90, a first manufacturing apparatus 11 that manufactures an intermediate roll 20F that is an intermediate product, and a second manufacturing apparatus 12 that acquires the intermediate roll 20F from the first manufacturing apparatus 11.

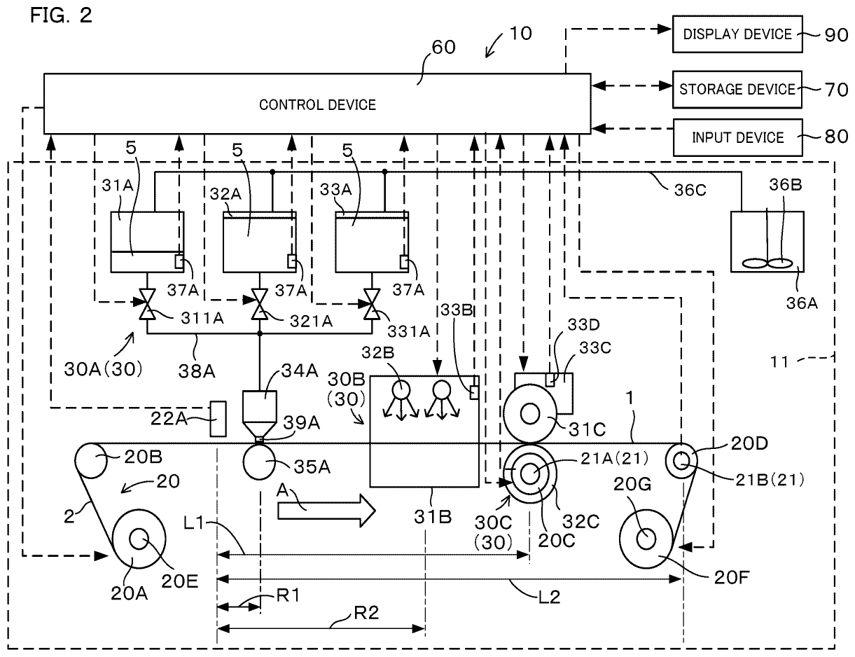

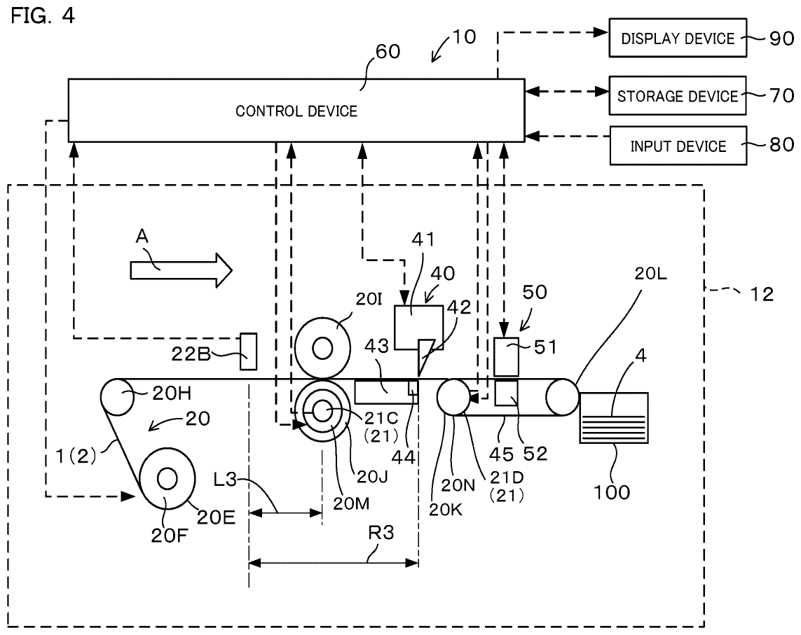

FIG. 2 shows the first manufacturing apparatus 11, the control device 60, the storage device 70, the input device 80, and the display device 90 of the electrode manufacturing apparatus 10. FIG. 4 shows the second manufacturing apparatus 12, the control device 60, the storage device 70, the input device 80, and the display device 90 of the electrode manufacturing apparatus 10. As shown in FIGS. 2 and 4, the electrode manufacturing apparatus 10 of the present embodiment is an apparatus for manufacturing an electrode 1 (example of the long product) of, for example, a lithium ion secondary battery (not shown). The electrode manufacturing apparatus 10 of the present embodiment manufactures the electrode 1 in which an active material layer 3 containing an active material is formed on at least one surface of a long metal foil 2 (example of the long material), and further cuts the electrode 1 to a predetermined length to manufacture electrode sheets 4.

As shown in FIG. 2, the first manufacturing apparatus 11 includes a feeding device 20, a feeding amount detection device 21, a first reference position detection device 22A (example of a reference position detection device), and a processing device 30. As shown in FIG. 4, the second manufacturing apparatus 12 includes the feeding device 20, the feeding amount detection device 21, a second reference position detection device 22B (example of the reference position detection device), a cutting device 40, and an engraving device 50.

### 2-2. Feeding Device 20

As shown in FIG. 2, the feeding device 20 includes an unwinding roll 20A, a first transport roll 20B, a first transport motor 20C, a second transport roll 20D, and an intermediate roll 20F. The metal foil 2 is wound around the unwinding roll 20A. When the electrode 1 is a cathode sheet, the metal foil 2 is made of, for example, aluminum. When the electrode 1 is an anode sheet, the metal foil 2 is made of, for example, copper.

The metal foil 2 sent out from the unwinding roll 20A is laid between the first transport roll 20B and the second transport roll 20D.

The first transport motor 20C is attached to a second pressing roll 32C of the processing device 30 described later. When the first transport motor 20C rotates the second pressing roll 32C, the metal foil 2 is nipped and pulled between a first pressing roll 31C described later and the second pressing roll 32C. Thus, the metal foil 2 is unwound from the unwinding roll 20A. The first transport roll 20B transports the metal foil 2 downstream in a feeding direction A indicated by arrow A. The metal foil 2 is wound around the intermediate roll 20F via the second transport roll 20D.

A brake 20E is attached to the unwinding roll 20A. Thus, tension is applied between the second pressing roll 32C and the unwinding roll 20A to prevent slack of the metal foil 2.

A winding motor 20G is attached to the intermediate roll 20F. Thus, tension is applied between the second transport roll 20D and the intermediate roll 20F to prevent slack of the metal foil 2.

The first transport motor 20C is controlled by the control device 60 to rotate or stop. The control device 60 controls the rotation speed of the first transport motor 20C. The first transport motor 20C is operated continuously.

As shown in FIG. 4, the feeding device 20 further includes a third transport roll 20H, a fourth transport roll 20I, a fifth transport roll 20J, a sixth transport roll 20K, a seventh transport roll 20L, a second transport motor 20M, and a third transport motor 20N.

The metal foil 2 sent out from the intermediate roll 20F is laid over the third transport roll 20H. The metal foil 2 is nipped between the fourth transport roll 201 and the fifth transport roll 20J. The second transport motor 20M is attached to the fifth transport roll 20J. When the second transport motor 20M rotates the fifth transport roll 20J, the electrode 1 nipped between the fourth transport roll 201 and the fifth transport roll 20J is pulled. Thus, the electrode 1 is unwound from the intermediate roll 20F. The third transport roll 20H transports the metal foil 2 downstream in a feeding direction A indicated by arrow A. A brake 20E is attached to the intermediate roll 20F. Thus, tension is applied between the fifth transport roll 20J and the intermediate roll 20F to prevent slack of the electrode 1.

The electrode 1 transported from the fourth transport roll 201 and the fifth transport roll 20J is placed on a belt conveyor 45. The belt conveyor 45 is driven by the sixth transport roll 20K and the seventh transport roll 20L, and the electrode 1 placed on the belt conveyor 45 is transported downstream in the feeding direction A.

The third transport motor 20N that drives the sixth transport roll 20K is attached to the sixth transport roll 20K.

The second transport motor 20M and the third transport motor 20N are controlled by the control device 60 to rotate or stop. The control device 60 controls the rotation speeds of the second transport motor 20M and the third transport motor 20N. The second transport motor 20M and the third transport motor 20N are operated to alternately repeat operation and stop, namely operated intermittently.

### 2-3. Feeding Amount Detection Device 21

As shown in FIG. 2, the feeding amount detection device 21 includes a first encoder 21A and a second encoder 21B (example of a post-rolling feeding amount detection device). As shown in FIG. 4, the feeding amount detection device 21 further includes a third encoder 21C (example of the post-rolling feeding amount detection device) and a fourth encoder 21D (example of the post-rolling feeding amount detection device).

As shown in FIG. 2, the first encoder 21A is disposed on the first transport motor 20C. The first encoder 21A detects a feeding amount R of the metal foil 2 in the feeding direction A. The first encoder 21 A outputs information corresponding to the rotation speed of the first transport motor 20C as an electric signal. The first encoder 21A transmits the electric signal to the control device 60. The control device 60 that acquires the electric signal from the first encoder 21A calculates the feeding amount R of the metal foil 2 from the acquired electric signal. The control device 60 may control the rotation speed of the first transport motor 20C based on the calculated feeding amount R of the metal foil 2.

There are no particular limitations on the method for using the signal related to the rotation speed detected by the first encoder 21A as data related to the feeding amount R. For example, the following two methods can be adopted.

The first method is to calculate the feeding amount R based on the signal related to the rotation speed detected by the first encoder 21A and the radius of the second pressing roll 32C. When the rotation angle of the first transport motor 20C detected by the first encoder 21A is X° and the radius of the second pressing roll 32C is r, the feeding amount R is calculated by the following expression.

R=2π×r×X÷360

When the rotation angle of the first transport motor 20C is X radians, the feeding amount R is calculated by the following expression.

R=r×X

The radius r of the second pressing roll 32C may be input to an initial setting screen when the electrode manufacturing apparatus 10 is started. The radius r of the second pressing roll 32C may be actually measured by a sensor (not shown). The corresponding radius r may be received from a database stored in a storage device (not shown). Any method can be selected as appropriate.

The second method for using the signal related to the rotation speed detected by the first encoder 21A as data related to the feeding amount R is to calculate the feeding amount R based on the number of pulses transmitted by the first encoder 21A. For example, the feeding amount R of the second pressing roll 32C can be calculated by calculating a difference between the number of pulses before the second pressing roll 32C performs the feeding operation and the number of pulses when the second pressing roll 32C is performing the feeding operation, and multiplying the difference in the number of pulses by a unit feeding amount of the second pressing roll 32C.

The number of pulses per unit feeding amount of the second pressing roll 32C can be calculated by reading, when the feeding operation of the second pressing roll 32C is performed by the unit feeding amount, the number of pulses of the first encoder 21A before the feeding operation is performed and the number of pulses of the first encoder 21A after the feeding operation is performed, and calculating a difference between the numbers of pulses. The number of pulses per unit feeding amount of the second pressing roll 32C may be input to the initial setting screen when the electrode manufacturing apparatus 10 is started. Any method can be selected as appropriate.

The first transport motor 20C that is the detection target of the first encoder 21A is a so-called position motor. The first transport motor 20C is configured such that the movement amount and the movement speed can be set. During the operation of the electrode manufacturing apparatus 10, the movement amount of the first transport motor 20C is set to infinity, and the movement speed is set to a predetermined setting value. Since the quality of processing is also affected by the movement speed, the first encoder 21A detects the movement speed as speed data for each unit feeding amount of the metal foil 2 by the first transport motor 20C, and transmits it to the control device 60. However, the movement speed of the first transport motor 20C may be constant during the operation of the electrode manufacturing apparatus 10, or may change over time. When the movement speed changes over time, it may change continuously over time, or may change stepwise over time.

However, the feeding amount detection device 21 is not limited to the encoder, and may be, for example, an optical sensor such as a CCD camera provided separately from the first transport motor 20C. In this case, the movement amount of the metal foil 2 in the feeding direction A can be detected by the optical sensor, and information related to the movement amount can be transmitted to the control device 60.

### 2-4. First Reference Position Detection Device 22A and Second Reference Position Detection Device 22B

As shown in FIG. 2, in the first manufacturing apparatus 11, the first reference position detection device 22A is disposed at a position downstream of the first transport roll 20B and upstream of a coating head 34A described later in the feeding direction A. The first reference position detection device 22A detects a reference position Re on the metal foil 2.

The reference position Re is a reference for the position on the metal foil 2 in the feeding direction A. The reference position Re is set to any position on the metal foil in the feeding direction A. However, the reference position Re may be the starting end of the metal foil 2. The reference position Re may be a position that is different from the starting end and is near the starting end. For example, when the shape or performance of the starting end of the metal foil 2 is unstable, the reference position Re may be a position that is close to the starting end of the metal foil 2 and where the shape or performance of the metal foil 2 is stable.

The first reference position detection device 22A is configured to detect the reference position Re on the metal foil 2. The first reference position detection device 22A is not particularly limited, and may be an optical sensor such as a laser sensor or a CCD camera, or a mechanical sensor that can detect the reference position Re by contact with the metal foil 2. Any sensor can be selected as appropriate. The first reference position detection device 22A transmits the detected reference position Re on the metal foil 2 to the control device 60.

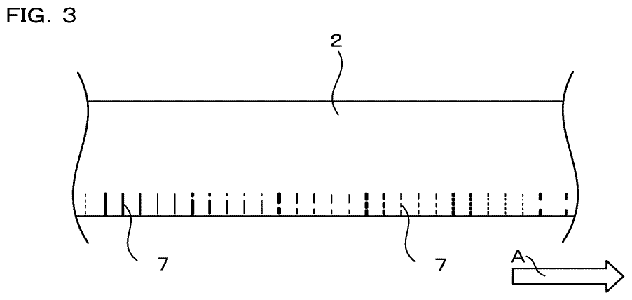

When both the feeding amount detection device 21 and the first reference position detection device 22A are optical sensors, for example, one optical sensor may serve as both the feeding amount detection device 21 and the first reference position detection device 22A. In this case, as shown in FIG. 3, for example, it is conceivable to display position information on at least one side edge of the metal foil 2. It is conceivable to form, for example, a plurality of score lines 7 at intervals along the feeding direction A as the position information. However, the score lines 7 may be formed on both side edges of the metal foil 2. The score lines 7 may be formed at equal intervals in the feeding direction A, or may be formed at unequal intervals.

The score line 7 is formed in a line or bar shape extending in a direction intersecting the feeding direction A. The score line 7 may be engraved or printed on the metal foil 2 and is formed on the metal foil 2 by any method. The plurality of score lines 7 is distinguishable from one another. The score lines 7 are distinguishable by any method such as a difference between the width dimensions of the score lines 7 in the feeding direction A, a difference between the length dimensions of the score lines 7 in a direction intersecting the feeding direction A, or the numbers of missing portions in the score lines 7 in a direction intersecting the feeding direction A. By detecting the score lines 7 using the above optical sensor, the position information related to the feeding direction A of the metal foil 2 can be acquired. Thus, it is possible to distinguish the processing performed on the metal foil 2, the cutting position, etc.

The feeding amount detection device 21 may transmit a signal to the control device 60 when the metal foil 2 is sent out by a predetermined amount. The first reference position detection device 22A may transmit a signal to the control device 60 when the metal foil 2 is sent out by a predetermined amount from the reference position Re.

For example, in a configuration in which a signal is transmitted to the control device 60 when the metal foil 2 is sent out by 10 mm, it is preferable that a distance L1 between the first reference position detection device 22A and the feeding amount detection device 21 be an integer multiple of 10 mm. Therefore, the signals received by the control device 60 can be organized in units of 10 mm. As a result, quality control of the electrode 1 can be performed easily. The distance L1 to the feeding amount detection device 21 is not limited to an integer multiple of 10 mm, and can be set to an integer multiple of any value.

The distance between each of the processing device 30, the cutting device 40, and the engraving device 50 described later and the reference position detection device 22 may also be, for example, an integer multiple of 10 mm. In other words, the distance between the first reference position detection device 22A and each of the processing device 30, the cutting device 40, and the engraving device 50 may be an integer multiple of a reference value of the distance LI between the first reference position detection device 22A and the feeding amount detection device 21. The distance between the first reference position detection device 22A and each of the processing device 30, the cutting device 40, and the engraving device 50 is not limited to an integer multiple of 10 mm, and can be set to an integer multiple of any value.

The distance between the first reference position detection device 22A and the second encoder 21B of the second transport roll 20D is L2. The distance between the first reference position detection device 22A and the second encoder 21B of the second transport roll 20D can be stored in association with L2.

In the present embodiment, the first reference position detection device 22A and the coating head 34A are disposed away from each other by a reference distance R1 in the feeding direction A. Specifically, the reference distance RI refers to a distance between a detection reference position of the first reference position detection device 22A and a central position of the coating head 34A. The detection reference position of the first reference position detection device 22A is an optical axis when the first reference position detection device 22A is an optical sensor, and is a contact position with the metal foil 2 when the first reference position detection device 22A is a mechanical sensor. The central position of the coating head 34A means the center of the coating head 34A having a circular sectional shape.

The first reference position detection device 22A and a drying device 30B are disposed away from each other by a reference distance R2. Specifically, the reference distance R2 refers to a distance between the detection reference position of the first reference position detection device 22A and a middle position in a drying chamber 31B of the drying device 30B in the feeding direction A.

The method for inputting numerical values of the reference distance R1 and the reference distance R2 to the electrode manufacturing apparatus 10 is not particularly limited, and any method may be adopted as appropriate. For example, specific numerical values on design drawings of the electrode manufacturing apparatus 10 may be input to the electrode manufacturing apparatus 10.

The metal foil 2 may be transported along the feeding direction A using the reference position Re on the metal foil 2 as a landmark, and the reference distance R1 may be calculated based on a value detected by the first encoder 21A when the reference position Re reaches the center of an ejection port 39A. The metal foil 2 may be transported along the feeding direction A using the reference position Re on the metal foil 2 as a landmark, and the reference distance R1 may be calculated based on a value detected by the first encoder 21A when the reference position Re reaches the middle position in the drying chamber 31B in the feeding direction A.

As shown in FIG. 4, in the second manufacturing apparatus 12, the second reference position detection device 22B is disposed at a position downstream of the third transport roll 20H and upstream of the fifth transport roll 20J in the feeding direction A. The second reference position detection device 22B detects the reference position Re on the metal foil 2 (electrode 1). The second reference position detection device 22B has the same configuration as the first reference position detection device 22A, and therefore redundant description will be omitted.

### 2-5. Processing Device 30

As shown in FIG. 2, the processing device 30 includes a coating device 30A, the drying device 30B, and a rolling device 30C. The processing device 30 processes the metal foil 2 fed in the feeding direction A by the feeding device 20. The feeding device 20 performs continuous processing on the metal foil 2 in the feeding direction A. The processing device 30 processes the metal foil 2 by continuously changing a plurality of different processing conditions. The processing device 30 is not particularly limited. Any machining device that performs cutting, pressing, welding, etc. may be adopted. Any heat treatment device that performs baking, cooling, etc. may be adopted. Any processing device that performs printing, bonding, etc. may be adopted.

### (1) Coating Device 30A

The coating device 30A applies a coating material 5 containing an active material to at least one surface of the metal foil 2. The coating device 30A includes a first container 31A, a first valve 311A, a second container 32A, a second valve 321A, a third container 33A, a third valve 331A, the coating head 34A, a backup roll 35A, and an agitation tank 36A.

The agitation tank 36A includes a screw 36B. An active material, a conductive assistant, a binder, a solvent, etc. are placed in the agitation tank 36A and kneaded by the screw 36B to prepare the coating material 5. Specifically, when the electrode sheet 4 is a positive electrode, a lithium metal composite oxide (e.g., a lithium cobalt oxide, a lithium nickel oxide, or a lithium manganese oxide) etc. is used as the active material, acetylene black etc. is used as the conductive assistant, polyvinylidene fluoride etc. is used as the binder, and N-methylpyrrolidone etc. is used as the solvent. When the electrode sheet 4 is a negative electrode, graphite (e.g., acetylene black or ketjen black) etc. is used as the active material, SBR, polyacrylic acid, etc. is used as the binder, and water etc. is used as the solvent.

The coating material 5 prepared in the agitation tank 36A is transported through a line 36C to the first container 31A, the second container 32A, and the third container 33A. The line 36C is a known pipe.

A remaining amount sensor 37A is disposed inside the first container 31A to detect whether the remaining amount of the coating material 5 contained in the first container 31A falls below a lower limit value VL1. The remaining amount sensor 37A transmits, to the control device 60, information indicating that the remaining amount of the coating material 5 in the first container 31 A falls below the lower limit value VL1. The first container 31A may include a temperature sensor that detects the temperature of the coating material 5 contained in the first container 31A.

The second container 32A and the third container 33A have the same configuration as the first container 31A, and therefore redundant description will be omitted. In the present embodiment, the coating materials 5 having the same composition and prepared in the agitation tank 36A are transported to the first container 31A, the second container 32A, and the third container 33A. The number of containers is not particularly limited, and can be any number.

The coating head 34A ejects the coating material 5 supplied by a pump (not shown) from the ejection port 39A. The coating head 34A and the backup roll 35A are disposed to face each other across the metal foil 2. The coating head 34A ejects the coating material 5 at a predetermined ejection rate onto the surface of the metal foil 2 in contact with the backup roll 35A. Thus, the coating material 5 is applied to one surface of the metal foil 2. The surface of the metal foil 2 includes an exposed portion 6 where the active material layer 3 is not formed and the surface of the metal foil 2 is exposed. The ejection rate is important data that determines the quality of the coating material 5 in the step of applying the coating material 5 to the metal foil 2. The control device 60 controls the output of the pump to control the ejection rate of the coating material 5.

The first container 31A, the second container 32A, and the third container 33A are connected to the coating head 34A by a tubular line 38A through which the coating material 5 can flow. The first valve 311A is connected to the first container 31A. When the first valve 311A is opened, the coating material 5 is supplied from the first container 31A to the coating head 34A. When the first valve 311A is closed, the supply of the coating material 5 from the first container 31A to the coating head 34A is stopped.

The second valve 321A is connected to the second container 32A. When the second valve 321A is opened, the coating material 5 is supplied from the second container 32A to the coating head 34A. When the second valve 321A is closed, the supply of the coating material 5 from the second container 32A to the coating head 34A is stopped.

The third valve 331A is connected to the third container 33A. When the third valve 331A is opened, the coating material 5 is supplied from the third container 33A to the coating head 34A. When the third valve 331A is closed, the supply of the coating material 5 from the third container 33A to the coating head 34A is stopped.

The opening and closing of the first valve 311A, the second valve 321A, and the third valve 331A are controlled by the control device 60.

### (2) Drying Device 30B

The drying device 30B includes the drying chamber 31B and hot air generators 32B. The drying chamber 31B is disposed to surround the metal foil 2 being transported. In the drying chamber 31B, the hot air generators 32B are arranged along the feeding direction A of the metal foil 2. The hot air generators 32B blow, using fans (not shown), air heated by heaters (not shown) toward the metal foil 2 to which the coating material 5 is applied. Thus, the solvent contained in the coating material 5 evaporates, and the active material etc. are bound to the metal foil 2 by the binder, thereby forming the active material layer 3 on the metal foil 2. Drying of the metal foil 2 by the drying device 30B is an example of heat treatment.

A sensor 33B is disposed in the drying chamber 31B. The sensor 33B detects the temperature inside the drying chamber 31B. The sensor 33B may detect the air speed, humidity, etc. inside the drying chamber 31B. The sensor 33B transmits information about the state inside the drying chamber 31B to the control device 60.

### (3) Rolling Device 30C

The rolling device 30C thins the active material layer 3 formed by the drying device 30B. The rolling device 30C includes the first pressing roll 31C and the second pressing roll 32C. The first pressing roll 31C and the second pressing roll 32C are each formed in a cylindrical shape. The first pressing roll 31C and the second pressing roll 32C are disposed such that the central axis of the first pressing roll 31C and the central axis of the second pressing roll 32C are parallel to each other. The metal foil 2 on which the active material layer 3 is formed passes between the first pressing roll 31C and the second pressing roll 32C. When the first pressing roll 31C and the second pressing roll 32C rotate in opposite directions, the metal foil 2 on which the active material layer 3 is formed is pressurized while being transported, and the active material layer 3 is thinned to a predetermined thickness. As described above, the first transport motor 20C and the feeding amount detection device 21 are attached to the second pressing roll 32C. In the above manner, the electrode 1 is manufactured.

A pressure controller 33C is disposed on the first pressing roll 31C. The pressure controller 33C pressurizes the first pressing roll 31C toward the second pressing roll 32C by known means such as a hydraulic pressure or a servomotor. A pressure sensor 33D that detects the pressure from the first pressing roll 31C to the second pressing roll 32C is disposed on the pressure controller 33C. The pressure sensor 33D detects the pressure from the first pressing roll 31C to the second pressing roll 32C, and transmits it to the control device 60. The control device 60 controls the pressure controller 33C based on the pressure acquired from the pressure sensor 33D. The thinning of the active material layer 3 by the rolling device 30C is an example of machining.

When the electrode 1 is not expanded in the feeding direction A, the position on the electrode 1 or the metal foil 2 can be managed based on the position with respect to the reference position Re. The electrode 1 may be expanded in the feeding direction A at a predetermined expansion factor by the rolling device 30C. When the electrode 1 is expanded in the feeding direction A by the rolling device 30C, it is necessary to manage both the position with respect to the reference position Re in the state before rolling and the position with respect to the reference position Re in the state after rolling. The case where the electrode 1 is expanded in the feeding direction A by the rolling device 30C will be described in detail later.

### 2-6. Cutting Device 40

As shown in FIG. 4, the cutting device 40 includes a shearing device 41, a movable blade 42, a table 43, and a fixed blade 44. The movable blade 42 is attached to the shearing device 41, and is movable in the up-down direction by the shearing device 41. The table 43 supports, from below, the electrode 1 transported by the first pressing roll 31C and the second pressing roll 32C. The fixed blade 44 is fixed to the table 43 on the downstream side in the feeding direction A. The movable blade 42 is disposed to slide in the up-down direction in contact with the fixed blade 44.

As shown in FIG. 4, the second reference position detection device 22B and the cutting device 40 are disposed away from each other by a reference distance R3.

The shearing device 41 is controlled by the control device 60 to move the movable blade 42 downward and nip the electrode 1 between the movable blade 42 and the fixed blade 44. Thus, the electrode 1 is cut to a predetermined length dimension in the feeding direction A. The movable blade 42 is moved upward by the shearing device 41, and the cut electrode 1 is transported downstream in the feeding direction A. The cutting device 40 transmits, to the control device 60, a distance Di from the reference position Re on the electrode 1 cut by the movable blade 42 and the fixed blade 44. In the above manner, the electrode sheet 4 is manufactured. The electrode sheet 4 is transported by the known belt conveyor 45.

### 2-7. Engraving Device 50

The engraving device 50 includes an engraver 51 and a base 52. The upper surface of the base 52 is flat. By sandwiching the electrode sheet 4 between the engraver 51 and the base 52, an inscription 53 is provided on the exposed portion 6 of each electrode sheet 4. Different inscriptions 53 are engraved on the electrode sheets 4 to distinguish the electrode sheets 4. The inscription 53 may be any graphical objects such as letters, numbers, symbols, and figures as appropriate. The inscription 53 according to the present embodiment is a manufacturing number consisting of letters, numbers, and symbols. The inscription 53 may be a sticker affixed to the electrode sheet 4. The letters, numbers, or symbols may be formed by pressurizing the electrode sheet 4 to recede. Any form may be adopted. The engraver 51 links the distance Di of a cutting position downstream of the inscription from the reference position Re in the feeding direction A and the distance Di of a cutting position upstream of the inscription from the reference position Re in the feeding direction A, and transmits them to the control device 60.

### 2-8. Housing Device 100

The electrode sheet 4 provided with the inscription 53 is housed in a housing device 100. The housing device 100 may be, for example, a bag-shaped or box-shaped container that is open upward. The electrode sheets 4 are housed in the housing device 100 while being stacked.

### 2-9. Control Device 60

The control device 60 controls the start and stop of the feeding device 20, the processing device 30, the cutting device 40, and the engraving device 50. The control device 60 acquires various signals from the feeding amount detection device 21, the first reference position detection device 22A, the second reference position detection device 22B, the processing device 30, the cutting device 40, and the engraving device 50. The control device 60 stores the acquired signals in the storage device 70. The control device 60 causes the display device 90 to display a Gantt chart GC described later. The control device 60 acquires information about the quality of the manufactured electrode 1 or electrode sheet 4 from the input device 80.

As described above, the first reference position detection device 22A and the feeding amount detection device 21 are disposed away from each other by the predetermined distance L1. The control device 60 associates the feeding amount R acquired from the feeding amount detection device 21 with the distance L1 between the reference position detection device 22 and the feeding amount detection device 21. For example, the signal transmitted from the sensor 33D disposed in the rolling device 30C is associated with a difference (R−L1) between the feeding amount R and the distance L1.

The control device 60 may associate the signal from the sensor 37A of the coating device 30A with the feeding amount R and the reference distance R1 between the reference position detection device 22 and the coating head 34A. The control device 60 may associate the signal from the sensor 33B of the drying device 30B with the feeding amount R and the reference distance R2 between the reference position detection device 22 and the drying device 30B. The control device 60 may associate the signal from the cutting device 40 with the feeding amount R and the reference distance R3 between the second reference position detection device 22B and the cutting device 40.

### 2-10. Input Device 80

Information on the quality of the manufactured electrode 1 or electrode sheet 4 etc. is input to the input device 80. The input device 80 is an example of a quality input device. The input device 80 is not particularly limited, and may be known input means such as a keyboard, an external storage device, or an input port as appropriate.

### 2-11. Storage Device 70

The storage device 70 stores the processing conditions for the electrode 1 acquired from the control device 60 in association with the feeding amount R from the reference position Re acquired from the feeding amount detection device 21 in terms of a unit feeding amount for the feeding amount R from the reference position Re in the feeding direction A of the metal foil 1, or in terms of a unit period from the time when the reference position detection device 22A, 22B detects the reference position Re. The storage device 70 stores a plurality of processing conditions in association with the reference position Re on the electrode sheet 4 and the distance Di from the reference position Re. The storage device 70 stores data related to the state of the processing device 30 acquired from the various sensors 37A, 33B, 33D disposed on the processing device 30 in association with the reference position Re on the electrode sheet 4 and the distance Di from the reference position Re. The storage device 70 may store the data related to the state of the processing device 30 acquired from the various sensors 37A, 33B, 33D disposed on the processing device 30 in association with the difference (R−L1) between the feeding amount R and the distance L1 between the reference position detection device 22 and the feeding amount detection device 21. The storage device 70 stores the quality of the electrode 1 or the electrode sheet 4 in association with the reference position Re on the electrode sheet 4 and the distance Di from the reference position Re. The storage device 70 is not particularly limited, and may be a semiconductor storage device, a hard disk drive, or a cloud provided on a network.

The storage device 70 may store the signal from the sensor 37A of the coating device 30A in association with the feeding amount R and the reference distance R1 between the first reference position detection device 22A and the coating head 34A. The storage device 70 may store the signal from the sensor 33B of the drying device 30B in association with the feeding amount R and the reference distance R2 between the first reference position detection device 22A and the drying device 30B. The storage device 70 may store the signal from the cutting device 40 in association with the feeding amount R and the reference distance R3 between the second reference position detection device 22B and the cutting device 40.

The storage device 70 may store a pre-formatted table for storing data transmitted from the various sensors 37A, 33B, 33D and sequentially store pieces of data transmitted from the various sensors 37A, 33B, 33D in this table. Details will be described later.

### 2-12. Display Device 90

The display device 90 is not particularly limited, and may be, for example, a liquid crystal display attached to the electrode manufacturing apparatus 10, a tablet terminal separate from the electrode manufacturing apparatus 10, or a liquid crystal display of a computer connected to the electrode manufacturing apparatus 10 via a network.

The display device 90 may display the Gantt chart GC after all data has been stored in the table prestored in the storage device 70.

### 3. Electrode 1

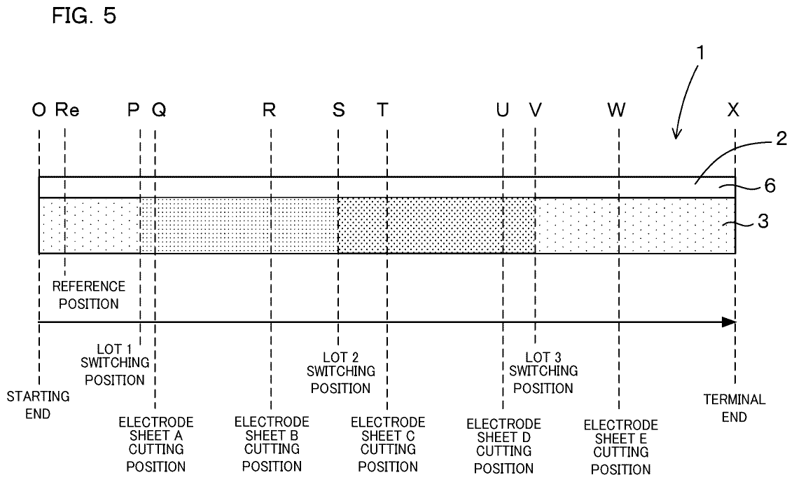

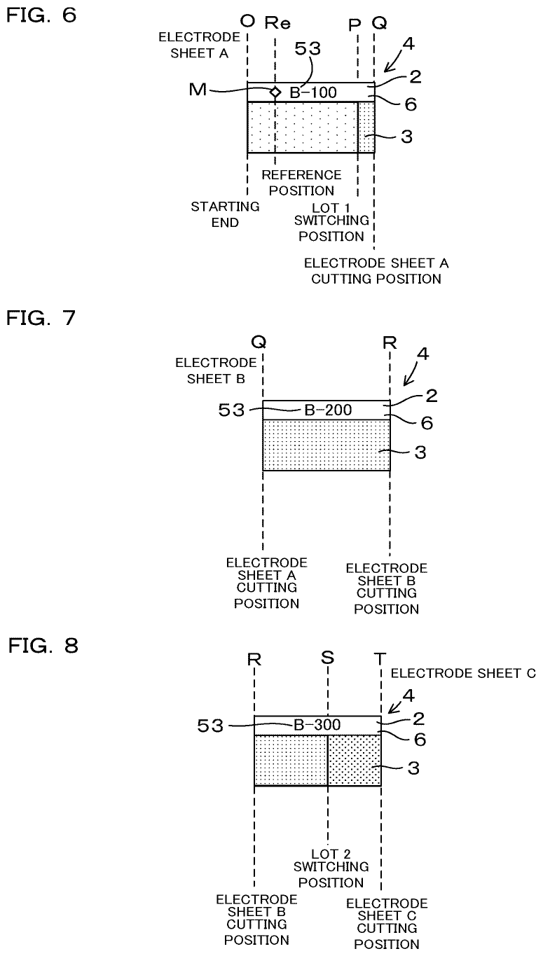

As shown in FIG. 5, the electrode 1 includes, on the surface of the metal foil 2, the active material layer 3 and the exposed portion 6 where the active material layer 3 is not formed and the surface of the metal foil 2 is exposed. The electrode 1 is formed in a rectangular shape that is long in the longitudinal direction. The electrode 1 includes a starting end O that is one end in the longitudinal direction, and a terminal end X that is the other end in the longitudinal direction. In the present embodiment, the electrode 1 has the reference position Re near the starting end. The reference position Re may be the starting end O of the electrode 1. When the shape or performance of the starting end O is unstable, the reference position Re may be a position that is close to the starting end O and where the shape or performance of the electrode 1 is stable. In this case, a mark M indicating the reference position Re may be engraved on the electrode 1 by the engraving device 50. In the present embodiment, a position close to the starting end O of the electrode 1 is set as the reference position Re, and the mark M is engraved at a corresponding position on the exposed portion 6 (see FIG. 6). In the present embodiment, the exposed portion 6 is formed along one side edge of the electrode 1 extending in the longitudinal direction. The exposed portion 6 may be formed along both side edges of the electrode 1 extending in the longitudinal direction. The shape of the mark M is not particularly limited, and any shape can be selected as appropriate.

The active material layer 3 is formed from Lot 1 corresponding to the coating material 5 supplied from the first container 31A, Lot 2 corresponding to the coating material 5 supplied from the second container 32A, and Lot 3 corresponding to the coating material 5 supplied from the third container 33A. In the present embodiment, the positions where the containers are switched will be referred to as a Lot 1 switching position P, a Lot 2 switching position S, and a Lot 3 switching position V in this order from the reference position Re. For ease of description, Lot 1, Lot 2, and Lot 3 are distinguished by different tones. The lot switching positions P, S, V are stored in the storage device 70 in association with the distance Di from the reference position Re on the electrode 1.

As described above, the electrode 1 is cut by the cutting device 40 to manufacture the electrode sheets 4. The number of electrode sheets 4 cut out from one electrode 1 is not particularly limited. In the present embodiment, six electrode sheets 4, namely electrode sheets A to F, are manufactured. The storage device 70 stores cutting positions Q, R, T, U, W where the electrode sheets A to F of the electrode 1 are cut in association with the reference position Re on the electrode 1 and the distance Di from the reference position Re. Specifically, the cutting position of the electrode sheet A is an electrode sheet A cutting position Q, the cutting position of the electrode sheet B is an electrode sheet B cutting position R, the cutting position of the electrode sheet C is an electrode sheet C cutting position T, the cutting position of the electrode sheet D is an electrode sheet D cutting position U, and the cutting position of the electrode sheet E is an electrode sheet E cutting position W.

### 4. Electrode Sheets 4

FIGS. 6 to 11 show the electrode sheets A to F. The storage device 70 stores, for the electrode sheets A to F, the lot switching positions P, S, V, the cutting positions Q, R, T, U, W, the starting end O, and the terminal end X in association with the reference position Re on the electrode 1 and the distance Di from the reference position Re.

Details will be described below. The storage device 70 stores the distance Di of the position O of the starting end on the upstream side in the feeding direction A and the distance Di of the electrode sheet A cutting position Q on the downstream side in association with an inscription 53 showing “B-100” on the electrode sheet A.

The storage device 70 stores the distance Di of the electrode sheet A cutting position Q on the upstream side in the feeding direction A and the distance Di of the electrode sheet B cutting position R on the downstream side in the feeding direction A in association with an inscription 53 showing “B-200” on the electrode sheet B.

The storage device 70 stores the distance Di of the electrode sheet B cutting position R on the upstream side in the feeding direction A and the distance Di of the electrode sheet C cutting position T on the downstream side in the feeding direction A in association with an inscription 53 showing “B-300” on the electrode sheet C.

The storage device 70 stores the distance Di of the electrode sheet C cutting position T on the upstream side in the feeding direction A and the distance Di of the electrode sheet D cutting position U on the downstream side in the feeding direction A in association with an inscription 53 showing “B-400” on the electrode sheet D.

The storage device 70 stores the distance Di of the electrode sheet D cutting position U on the upstream side in the feeding direction A and the distance Di of the electrode sheet E cutting position W on the downstream side in the feeding direction A in association with an inscription 53 showing “B-500” on the electrode sheet E.

The storage device 70 stores the distance Di of the electrode sheet E cutting position W on the upstream side in the feeding direction A and the distance Di of the terminal end X on the downstream side in the feeding direction A in association with an inscription 53 showing “B-600” on the electrode sheet F.

In the present embodiment, the lot switching positions P, S, V of the first container 31A to the third container 33A do not coincide with the cutting positions Q, R, T, U, W of the electrode sheets A to F. The lot switching positions of the first container 31A to the third container 33A may coincide with the cutting positions of the electrode sheets A to F.

FIG. 6 shows the electrode sheet A. The electrode sheet A is formed in a rectangular shape between the starting end O and the electrode sheet A cutting position Q. The inscription 53 showing “B-100” is engraved on the exposed portion 6 of the electrode sheet A. The mark M indicating the reference position Re is engraved upstream of the inscription 53 showing “B-100” on the exposed portion 6 of the electrode sheet A. The mark M has any shape. The active material layer 3 on the electrode sheet A is formed from Lot 1 corresponding to the coating material 5 prepared in the first container 31A and Lot 2 corresponding to the coating material 5 prepared in the second container 32A. The switching position between Lot 1 and Lot 2 is the Lot 1 switching position P.

FIG. 7 shows the electrode sheet B. The electrode sheet B is formed in a rectangular shape between the electrode sheet A cutting position Q and the electrode sheet B cutting position R. The inscription 53 showing “B-200” is engraved on the exposed portion 6 of the electrode sheet B. The active material layer 3 on the electrode sheet B is formed from Lot 2 corresponding to the coating material 5 prepared in the second container 32A.

FIG. 8 shows the electrode sheet C. The electrode sheet C is formed in a rectangular shape between the electrode sheet B cutting position R and the electrode sheet C cutting position T. The inscription 53 showing “B-300” is engraved on the exposed portion 6 of the electrode sheet C. The active material layer 3 on the electrode sheet C is formed from Lot 2 corresponding to the coating material 5 prepared in the second container 32A and Lot 3 corresponding to the coating material 5 prepared in the third container 33A. The switching position between Lot 2 and Lot 3 is the Lot 2 switching position S.

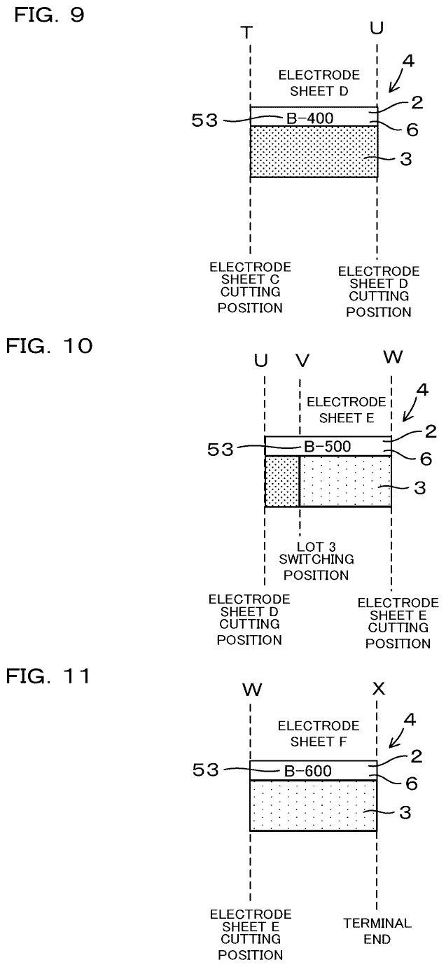

FIG. 9 shows the electrode sheet D. The electrode sheet D is formed in a rectangular shape between the electrode sheet C cutting position T and the electrode sheet D cutting position U. The inscription 53 showing “B-400” is engraved on the exposed portion 6 of the electrode sheet D. The active material layer 3 on the electrode sheet D is formed from Lot 3 corresponding to the coating material 5 prepared in the third container 33A.

FIG. 10 shows the electrode sheet E. The electrode sheet E is formed in a rectangular shape between the electrode sheet D cutting position U and the electrode sheet E cutting position W. The inscription 53 showing “B-500” is engraved on the exposed portion 6 of the electrode sheet E. The active material layer 3 on the electrode sheet E is formed from Lot 3 corresponding to the coating material 5 prepared in the third container 33A and Lot 4 corresponding to the coating material 5 prepared in the first container 31A. The switching position between Lot 3 and Lot 1 is the Lot 3 switching position V.

FIG. 11 shows the electrode sheet F. The electrode sheet F is formed in a rectangular shape between the electrode sheet E cutting position W and the terminal end X. The inscription 53 showing “B-600” is engraved on the exposed portion 6 of the electrode sheet F. The active material layer 3 on the electrode sheet F is formed from Lot 4 corresponding to the coating material 5 prepared in the first container 31A.

### 5. Operation of Electrode Manufacturing Apparatus 10

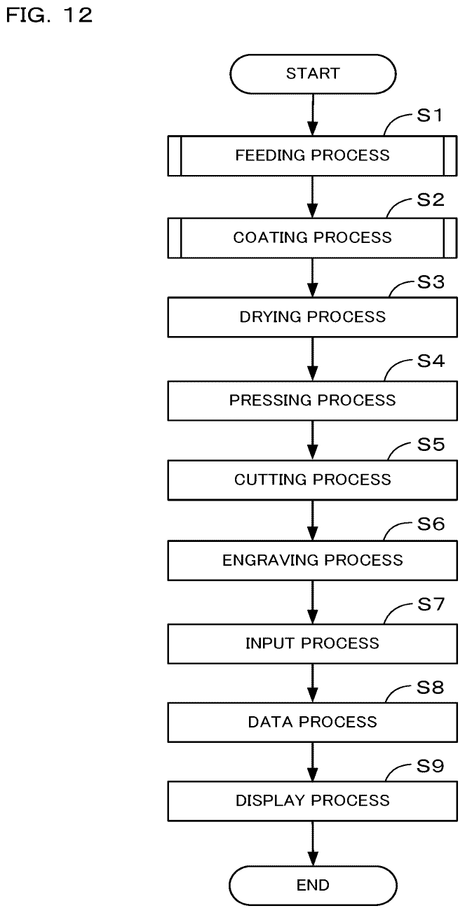

The operation of the electrode manufacturing apparatus 10 of the present embodiment will be described with reference to FIGS. 12 to 23. FIG. 12 shows a main flow of the electrode manufacturing apparatus 10. When the electrode manufacturing apparatus 10 is started, a feeding process (S1) is performed.

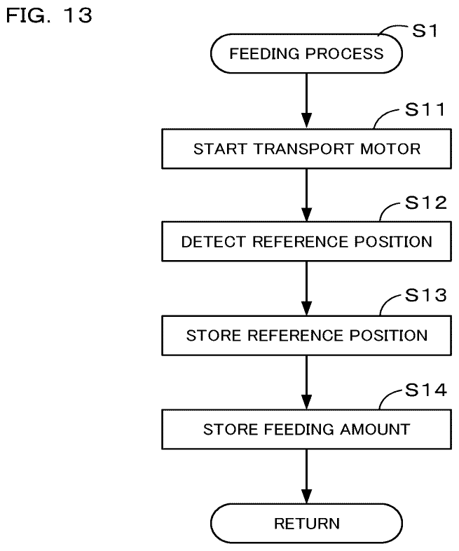

FIG. 13 is a flowchart of the feeding process (S1). When the feeding process (S1) is performed, the first transport motor 20C is started (S11). In a case where a motor for the unwinding roll 20A is attached to the unwinding roll 20A, the motor for the unwinding roll 20A may be started. The rotation amount of the first transport motor 20C is detected by the feeding amount detection device 21. The feeding amount detection device 21 transmits the rotation amount of the first transport motor 20C to the control device 60.

When the first transport motor 20C is started and the metal foil 2 is sent out from the unwinding roll 20A, the reference position Re on the metal foil 2 is detected by the reference position detection device 22 (S12). The reference position detection device 22 transmits the detected reference position Re to the control device 60.

The control device 60 stores the reference position Re acquired from the reference position detection device 22 in the storage device 70 (S13).

The control device 60 calculates the distance Di from the reference position Re on the metal foil 2 based on the feeding amount acquired from the feeding amount detection device 21. In the configuration in which the metal foil 2 is not expanded in the feeding direction A, the control device 60 calculates the distance Di from the reference position Re based on the feeding amount R acquired from the feeding amount detection device 21.

The control device 60 stores the calculated distance Di from the reference position Re in the storage device 70 (S14).

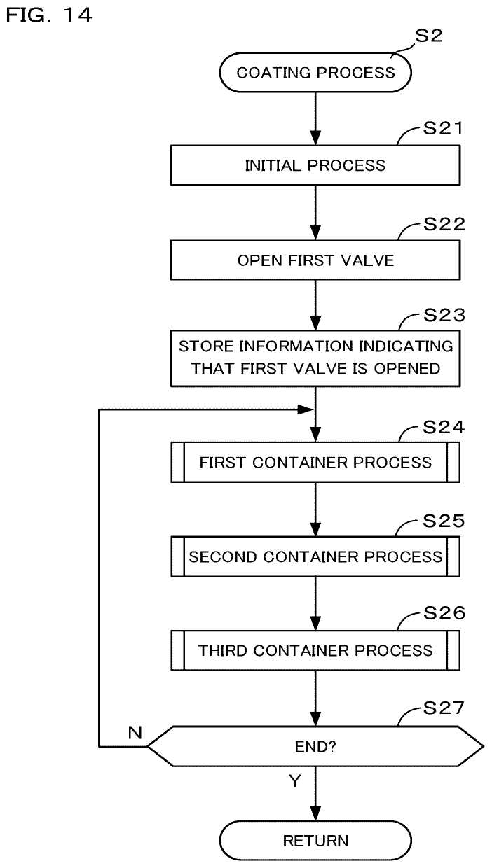

Returning to FIG. 12, when the feeding process (S1) is completed, a coating process (S2) is performed. FIG. 14 is a flowchart of the coating process (S2). When the coating process (S2) is performed, an initial process (S21) is performed.

In the initial process (S21), predetermined raw materials are charged into the agitation tank 36A and kneaded by the screw 36B to prepare the coating material 5. The coating material 5 is transported from the agitation tank 36A into the first container 31A to the third container 33A through the line 36C. When a usable coating material 5 remains in any of the first container 31A to the third container 33A, the process may be performed using the remaining coating material 5. The present embodiment illustrates a mode in which the coating material 5 remaining in the first container 31A is used first.

The order of use of the first container 31A to the third container 33A is not particularly limited. The number of containers is not particularly limited. All of the plurality of containers may be used, or a selected part of the plurality of containers may be used.

When the initial process is completed, the pump (not shown) is started and the first valve 311A is opened (S22). Thus, the coating material 5 in the first container 31A is transferred to the coating unit through the line 38A.

The control device 60 stores, in the storage device 70, information indicating that the first valve 311A is opened in association with the reference position Re on the metal foil 2 and the distance Di from the reference position Re (S23).

Next, a first container process (S24) is performed, a second container process (S25) is performed, and a third container process (S26) is performed.

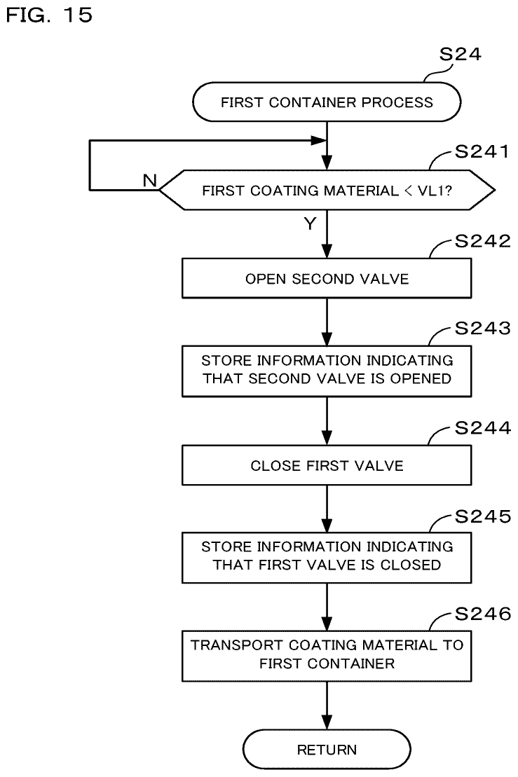

Next, the first container process (S24) will be described with reference to FIG. 15. When the first container process is performed (S24), determination is made as to whether the amount of the coating material 5 in the first container is less than the predetermined lower limit value VL1 (S241). When the amount of the coating material 5 in the first container 31A is not less than the predetermined remaining amount (S241: N), step S241 is repeated.

When the amount of the coating material 5 in the first container 31A is less than the predetermined lower limit value VL1 (S241: Y), the control device 60 opens the second valve 321A (S242). Thus, the coating material 5 contained in the second container 32A is transported to the coating head 34A by the pump.

The control device 60 stores, in the storage device 70, information indicating that the second valve 321A is opened in association with the reference position Re and the distance Di from the reference position Re (S243).

The control device 60 closes the first valve 311A (S244). The control device 60 stores, in the storage device 70, information indicating that the first valve 311A is closed in association with the reference position Re and the distance Di from the reference position Re (S245).

Next, the coating material 5 is transported from the agitation tank 36A to the first container 31A through the line 36C (S246). Thus, in the third container process (S26) described later, the coating material 5 transported into the first container 31A can be transported to the coating head 34A.

Accordingly, the first container process (S24) is completed.

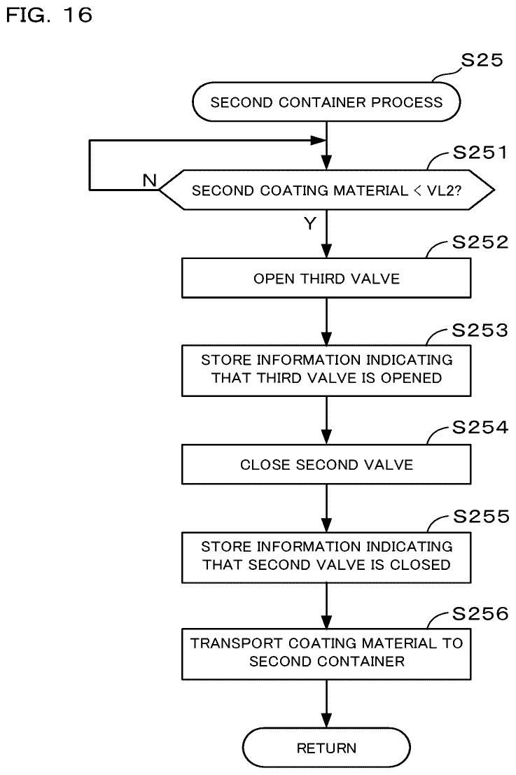

Next, the second container process (S25) will be described with reference to FIG. 16. When the second container process is performed (S25), determination is made as to whether the amount of the coating material 5 in the second container is less than a predetermined lower limit value VL2 (S251). When the amount of the coating material 5 in the second container 32A is not less than the predetermined remaining amount (S251: N), step S251 is repeated.

When the amount of the coating material 5 in the second container 32A is less than the predetermined lower limit value VL2 (S251: Y), the control device 60 opens the third valve 331A (S252). Thus, the coating material 5 contained in the third container 33A is transported to the coating head 34A by the pump.

The control device 60 stores, in the storage device 70, information indicating that the third valve 331A is opened in association with the reference position Re and the distance Di from the reference position Re (S253).

The control device 60 closes the second valve 321A (S254). The control device 60 stores, in the storage device 70, information indicating that the second valve 321A is closed in association with the reference position Re and the distance Di from the reference position Re (S255).

Next, the coating material 5 is transported from the agitation tank 36A to the second container 32A through the line 36C (S256). Thus, in the first container process (S24) described above, the coating material 5 transported into the second container 32A can be transported to the coating head 34A.

Accordingly, the second container process (S25) is completed.

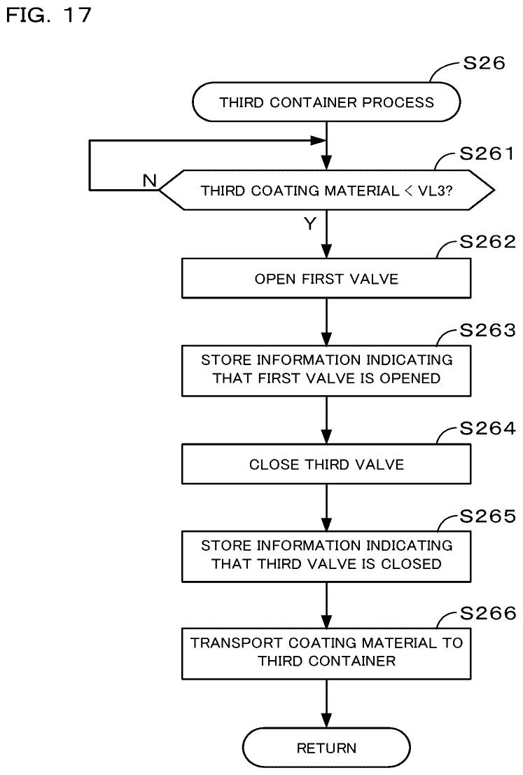

Next, the third container process (S26) will be described with reference to FIG. 17. When the third container process is performed (S26), determination is made as to whether the amount of the coating material 5 in the third container 33A is less than a predetermined lower limit value VL3 (S261). When the amount of the coating material 5 in the third container 33A is not less than the predetermined remaining amount (S261: N), step S261 is repeated.

When the amount of the coating material 5 in the third container 33A is less than the predetermined lower limit value VL3 (S261: Y), the control device 60 opens the first valve 311A (S262). Thus, the coating material 5 contained in the first container 31A is transported to the coating head 34A by the pump.

The control device 60 stores, in the storage device 70, information indicating that the first valve 311A is opened in association with the reference position Re and the distance Di from the reference position Re (S263).

The control device 60 closes the third valve 331A (S264). The control device 60 stores, in the storage device 70, information indicating that the third valve 331A is closed in association with the reference position Re and the distance Di from the reference position Re (S265).

Next, the coating material 5 is transported from the agitation tank 36A to the third container 33A through the line 36C (S266). Thus, in the second container process (S25) described above, the coating material 5 transported into the third container 33A can be transported to the coating head 34A.

Accordingly, the third container process (S26) is completed.

Returning to FIG. 14, after the third container process (S26) has been performed, determination is made as to whether to end the operation of the electrode manufacturing apparatus 10 (S27). When the operation of the electrode manufacturing apparatus 10 is not to be ended (S27: N), the process returns to S24 to repeat the processes of S24 to S26 (FIG. 14), S241 to S246 (FIG. 15), S251 to S256 (FIG. 16), and S261 to S266 (FIG. 17).

When the operation of the electrode manufacturing apparatus 10 is to be ended (S27: Y), the coating process (S2) is ended.

Returning to FIG. 12, when the coating process (S2) is completed, a drying process (S3) is performed. The metal foil 2 to which the coating material 5 is applied is dried by the drying device 30B. The sensor 33B disposed on the drying device 30B detects the state (temperature, air speed, humidity, etc.) of the drying device 30B, and transmits the state to the control device 60. The control device 60 stores, in the storage device 70, the state of the drying device 30B acquired from the sensor in association with the reference position Re and the distance Di from the reference position Re.

Next, a pressing process is performed (S4). The active material layer 3 applied to the metal foil 2 is compressed to a predetermined thickness by the rolling device 30C. In this manner, the electrode 1 is manufactured. The sensor 33D disposed on the rolling device 30C detects the state (pressure, temperature, etc.) of the rolling device 30C, and transmits the state to the control device 60. The control device 60 stores, in the storage device 70, the state of the rolling device 30C acquired from the sensor 33D in association with the reference position Re and the distance Di from the reference position Re.

For example, in the case where the metal foil 2 is expanded in the feeding direction A at a predetermined expansion factor, the control device 60 stores the distance Di calculated from the feeding amount R acquired from the feeding amount detection device 21, and also stores both the feeding amount R acquired from the feeding amount detection device 21 and a value obtained by multiplying the distance Di calculated from the feeding amount R by the expansion factor. The metal foil 2 may be expanded at any expansion factor.

Next, a cutting process is performed (S5). The electrode 1 is cut to a predetermined length dimension in the feeding direction A by the cutting device 40. The cutting device 40 transmits, to the control device 60, the position where the electrode 1 is cut. The control device 60 stores, in the storage device 70, the cutting positions Q, R, T, U, W acquired from the cutting device 40 in association with the reference position Re and the distance Di from the reference position Re.

Next, an engraving process is performed (S6). The engraving device 50 forms the inscription 53 on the exposed portion 6 of each electrode sheet 4. The engraving device 50 transmits information corresponding to the inscription 53 to the control device 60. The information corresponding to the inscription 53 is not particularly limited. Examples thereof include a lot number, purpose of use, and specifications of the electrode sheet 4. The present embodiment illustrates an example in which the signs to distinguish the electrode sheets 4 are combinations of an alphabet and numbers. The control device 60 stores, in the storage device 70 (example of an inscription-related information storage device), the information corresponding to the inscription 53 acquired from the engraving device 50 in association with the reference position Re and the distance Di from the reference position Re. The electrode sheet 4 subjected to the engraving process is housed in the housing device 100.

When the engraving process (S6) is completed, an input process is performed (S7). In the input process, the quality of the electrode 1 or the electrode sheet 4 is input via the input device 80. The quality of the electrode 1 or the electrode sheet 4 is not particularly limited. Examples thereof include the thickness of the active material layer 3, the charge voltage, the discharge voltage, and the capacity. The quality of the electrode 1 or the electrode sheet 4 may be input by an operator using a keyboard (example of the input device 80), or may be input via an input port (example of the input device 80) from a measuring device that measures the thickness of the active material layer 3, the charge voltage, the discharge voltage, and the capacity.

In the input process (S7), the operator may input information related to a specific inscription 53 via a keyboard, a microphone, etc. The operator may select an item to be displayed on the vertical axis of the Gantt chart GC by inputting the item via the input device 80.

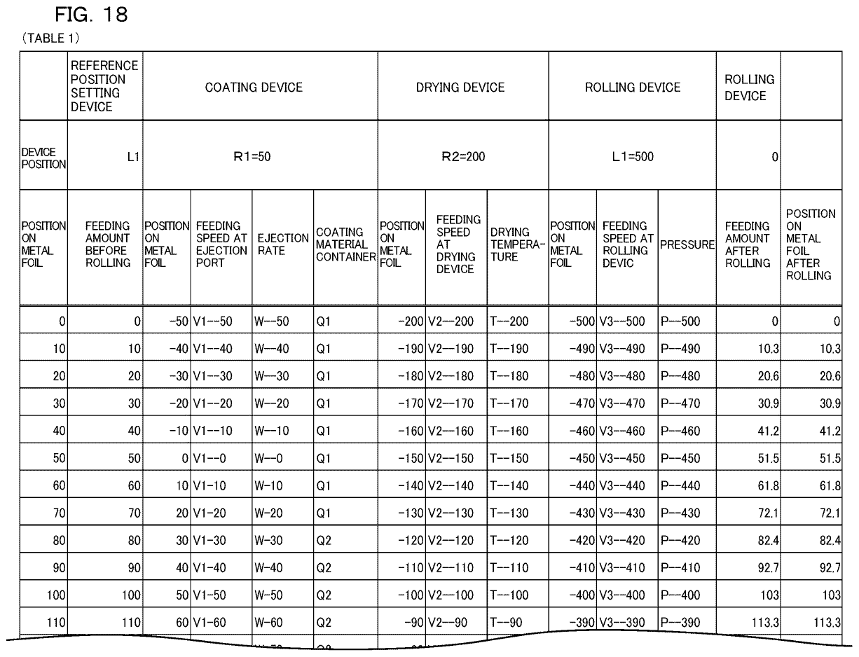

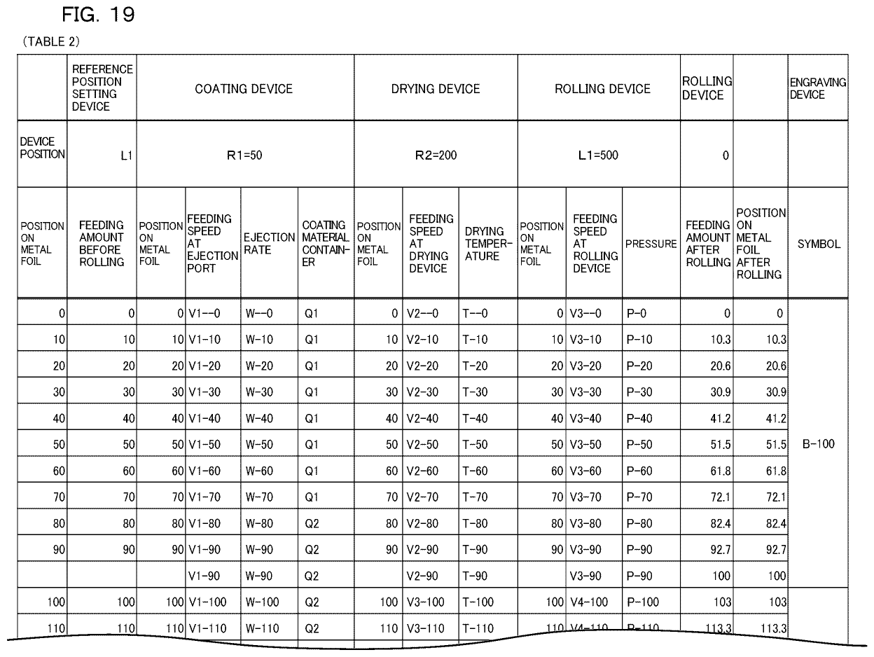

Next, a data process (S8) is performed. The data process (S8) will be described with reference to FIGS. 18 and 19. By performing the data process (S8), the position on the electrode 1 and the processing conditions can be stored in association with each other based on the reference position Re.

FIG. 18 shows part of Table 1. Table 1 is stored in the storage device 70. In Table 1, text information is shown in the area above the double line, and information related to the processing conditions is shown in the area below the double line. The area below the double line is blank before the electrode manufacturing apparatus 10 is started. After the electrode manufacturing apparatus 10 is started, information related to the processing conditions is transmitted from the control device 60 to the storage device 70, and is input and stored sequentially into the corresponding cells of Table 1. The format of Table 1 is not limited to the format described below, and any format may be adopted.

In Table 1, the top row includes, in order from the left, a blank field, “reference position setting device,” “coating device,” “drying device,” “rolling device,” “rolling device,” and a blank field.

In Table 1, the left end of the second row from the top shows “device position.” “L1” is shown below the cell “reference position setting device.” This indicates that the distance between the first reference position detection device 22A and the first encoder 21A is L1.

“R1=50” is shown below the cell “coating device.” This indicates that the reference distance between the ejection port 39A and the first reference position detection device 22A is R1, and R1 is set to 50 cm.

“R2=200” is shown below the cell “drying device.” This indicates that the reference distance between the central position of the drying device 30B and the first reference position detection device 22A in the feeding direction A is R2, and R2 is set to 200 cm.

“L1=500” is shown below the fifth cell “rolling device” from the left in the top row. This indicates that the reference distance between the rolling device 30C and the first reference position detection device 22A is L1, and L1 is set to 500 cm.

“0” is shown below the sixth cell “rolling device” from the left in the top row. This indicates that the rolling device 30C serves as a positional reference for the electrode 1 after rolling.

The third row from the top includes, in order from the left, “position on metal foil,” “feeding amount before rolling,” “position on metal foil,” “feeding speed at ejection port,” “ejection rate,” “coating material container,” “position on metal foil,” “feeding speed at drying device,” “drying device,” “position on metal foil,” “feeding speed at rolling device,” “pressure,” “feeding amount after rolling,” and “position on metal foil after rolling.”

“0” is input below the cell “position on metal foil” at the left end of the third row from the top. This means that the position on the metal foil 2 where the reference position Re is engraved is set to 0. “10,” “20,” “30,” . . . are input below the cell showing “0.” This means that, every time a position at the distance “10,” “20,” “30” from the reference position Re is detected during the operation of the electrode manufacturing apparatus 10, it is transmitted from the control device 60 to the storage device 70 and input to the corresponding cell of Table 1 in the storage device 70.

“0,”“10,” “20,” “30,” . . . are input below the second cell “feeding amount before rolling” from the left in the third row from the top. This means that, every time a position at the distance “10,” “20,” “30” from the reference position Re is detected by the first reference position detection device 22A in the state before the metal foil 2 (electrode 1) is rolled by the rolling device 30C during the operation of the electrode manufacturing apparatus 10, it is transmitted from the control device 60 to the storage device 70 and input to the corresponding cell of Table 1 in the storage device 70.

Values “−50,” “−40,” “−30,” “−20,” . . . are input below the third cell “position on metal foil” from the left in the third row from the top. This means that, when the reference position Re corresponds to the position of the first reference position detection device 22A, the position on the metal foil 2 at the position of the ejection port 39A is at a distance indicated by the value in the negative direction of the feeding direction A with respect to the reference position Re.

“V1—−50,”“V1—−40,” “V1—−30,” “V1—−20,” . . . are shown below the fourth cell “feeding speed at ejection port” from the left in the third row from the top. “V1−50,” “V1—−40,” “V1—−30,” “V1—−20,” . . . are feeding speeds of the metal foil 2 at the ejection port 39A, and specific numerical values are input. The unit is cm/sec. The values “−50,” “−40,” “−30,” “−20,” . . . in “V1—50,” “V1—−40,” “V1—−30,” “V1—−20,” . . . are the same as the above distances from the reference position Re. For example, the cell to which “V1—−50” is input means the feeding speed of the metal foil 2 at the position of the ejection port 39A when the reference position Re on the metal foil corresponds to the position of the first reference position detection device 22A. The cell to which “V1—−40” is input means the feeding speed of the metal foil 2 at the position of the ejection port 39A when the reference position Re on the metal foil is shifted by the distance “10” from the position of the first reference position detection device 22A. The same applies hereinafter, and therefore description will be omitted.

“W—−50,” “W—−40,” “W—−30,” “W—−20,” . . . are shown below the fifth cell “ejection rate” from the left in the third row from the top. “W—−50,” “W—−40,” “W 30,” “W—−20,” . . . are ejection rates of the coating material 5 to the metal foil 2 at the ejection port 39A, and specific numerical values are input. The unit is cc/sec. The values “−50,” “−40,” “−30,” “−20,” . . . in “W—−50,” “W—−40,” “W—−30,” “W—−20,” . . . are the same as the above distances from the reference position Re. For example, the cell to which “W—−50” is input means the ejection rate of the coating material 5 to the metal foil 2 at the position of the ejection port 39A when the reference position Re on the metal foil corresponds to the position of the first reference position detection device 22A. The cell to which “W−40” is input means the ejection rate of the coating material 5 to the metal foil 2 at the position of the ejection port 39A when the reference position Re on the metal foil is shifted by the distance “10” from the position of the first reference position detection device 22A. The same applies hereinafter, and therefore description will be omitted.

“Q1,” . . . “Q2,” . . . are shown below the sixth cell “coating material container” from the left in the third row from the top. Each of “Q1,” “Q2,” . . . means the container 31A, 32A, 33A that has supplied the coating material 5 ejected from the ejection port 39A. Any one of the containers 31A, 32A, 33A is input to each of “Q1,” . . . “Q2,” . . . In the present embodiment, based on the numerical values shown below the third cell “position on metal foil” from the left in the third row from the top, the coating material 5 is supplied from the container Q1 within the range from the position on the metal foil 2 at the ejection port 39A at the distance “50” in the negative direction of the feeding direction A from the reference position Re to the position at the distance “20” in the positive direction of the feeding direction, and the coating material 5 is supplied from the container Q2 within the range from the position at the distance “30” in the positive direction of the feeding direction.

Values “−200,” “−190,” “−180,” “−170,” . . . are input below the seventh cell “position on metal foil” from the left in the third row from the top. This means that, when the reference position Re corresponds to the position of the first reference position detection device 22A, the position on the metal foil 2 at the middle position in the drying chamber 31B in the feeding direction A is at a distance indicated by the value in the negative direction of the feeding direction A with respect to the reference position Re.

“V2—−200,” “V2—−190,” “V2—−180,” “V2—−170,” . . . are shown below the eighth cell “feeding speed at drying device” from the left in the third row from the top. “V2—−200,” “V2—−190,” “V2—−180,” “V2—−170,” . . . are feeding speeds of the metal foil 2 at the middle position in the drying chamber 31B in the feeding direction A, and specific numerical values are input. The unit is cm/sec. The values “−200,” “−190,” “−180,” “−170,” . . . in “V2—−200,”V2—−190,“V2—−180,” “V2—−170,” . . . are the same as the above distances from the reference position Re. For example, the cell to which “V2—−200” is input means the feeding speed of the metal foil 2 at the middle position in the drying chamber 31B in the feeding direction A when the reference position Re on the metal foil corresponds to the position of the first reference position detection device 22A. The cell to which “V2—−190” is input means the feeding speed of the metal foil 2 at the middle position in the drying chamber 31B in the feeding direction A when the reference position Re on the metal foil is shifted by the distance “10” from the position of the first reference position detection device 22A. The same applies hereinafter, and therefore description will be omitted.

“T—−200,” “T—−190,” “T—−180,” “T—−170,” are shown below the ninth cell “drying temperature” from the left in the third row from the top. “T—−200,” “T—−190,” “T—−180,” “T—−170,” . . . are temperatures inside the drying chamber 31B at the middle position in the drying chamber 31B in the feeding direction A, and specific numerical values are input. The values “−200,” “−190,” “−180,” “−170,” . . . in “T—−200,” “T—−190,” “T—−180,” “T—−170,” . . . are the same as the above distances from the reference position Re. For example, the cell to which “T—−200” is input means the temperature at the middle position in the drying chamber 31B in the feeding direction A when the reference position Re on the metal foil corresponds to the position of the first reference position detection device 22A. The cell to which “T—−190” is input means the temperature at the middle position in the drying chamber 31B in the feeding direction A when the reference position Re on the metal foil is shifted by the distance “10” from the position of the first reference position detection device 22A. The same applies hereinafter, and therefore description will be omitted.

Values “−500,” “−490,” “−480,” “−470,” . . . are input below the tenth cell “position on metal foil” from the left in the third row from the top. This means that, when the reference position Re corresponds to the position of the first reference position detection device 22A, the position on the metal foil 2 at the position of the rolling device 30C is at a distance indicated by the value in the negative direction of the feeding direction A with respect to the reference position Re.

“V3—−500,” “V3—−490,” “V3—−480,” “V3—−470,” . . . are shown below the eleventh cell “feeding speed at rolling device” from the left in the third row from the top. “V3—−500,” “V3—−490,” “V3—−480,” “V3—−470,” . . . are feeding speeds of the metal foil 2 at the position of the rolling device 30C, and specific numerical values are input. The unit is cm/sec. The values “−500,” “−490,” “−480,” “−470,” . . . in “V3—−500,” “V3—−490,” “V3—−480,” “V3—−470,” . . . are the same as the above distances from the reference position Re. For example, the cell to which “V3—−500” is input means the feeding speed of the metal foil 2 at the position of the rolling device 30C when the reference position Re on the metal foil corresponds to the position of the first reference position detection device 22A. The cell to which “V3—−490” is input means the feeding speed of the metal foil 2 at the position of the rolling device 30C when the reference position Re on the metal foil is shifted by the distance “10” from the position of the first reference position detection device 22A. The same applies hereinafter, and therefore description will be omitted.

“P—−500,” “P—−490,” “P—−480,” “P—−470,”. are shown below the twelfth cell “pressure” from the left in the third row from the top. “P—−500,” “P—−490,” “P—−480,” “P—−470,”. are pressures applied to the electrode 1 by the rolling device 30C, and specific numerical values are input. The values “−500,” “−490,” “−480,” “−470,” . . . in “P—−500,” “P—−490,”P—−480,“P—−470,” . . . are the same as the above distances from the reference position Re. For example, the cell to which “P—−500” is input means the pressure applied to the electrode 1 by the rolling device 30C when the reference position Re on the metal foil corresponds to the position of the first reference position detection device 22A. The cell to which “P—−490” is input means the pressure applied to the electrode 1 by the rolling device 30C when the reference position Re on the metal foil is shifted by the distance “10” from the position of the first reference position detection device 22A. The same applies hereinafter, and therefore description will be omitted.

“0” “10.3,” “20.6,” “30.9,” . . . are input below the thirteenth cell “feeding amount after rolling” from the left in the third row from the top. This indicates that, when the feeding amounts before rolling are “10,” “20,” “30,” . . . , the feeding amounts after rolling are “0,” “10.3,” “20.6,” “30.9,” . . . in the state after the metal foil 2 (electrode 1) is rolled by the rolling device 30C during the operation of the electrode manufacturing apparatus 10. In other words, the rolling factor of the electrode 1 in the rolling device 30C is 1.03. The rolling factor of the electrode 1 is not limited to the above value, and may be set to any value as appropriate.

“0,” “10.3,” “20.6,” “30.9,” . . . are input below the fourteenth cell “position on metal foil after rolling” from the left in the third row from the top. This indicates that the positions at the distances “10,” “20,” “30,” . . . from the reference position Re turn into “0,” “10.3,” “20.6,” “30.9,” . . . in the state after the metal foil 2 (electrode 1) is rolled by the rolling device 30C during the operation of the electrode manufacturing apparatus 10.

Table 1 shows what type of processing is performed on the electrode 1 or the metal foil 2 at the same time when the cells are viewed horizontally in the area below the double line.

Next, Table 2 will be described with reference to FIG. 19. FIG. 19 shows part of Table 2. Tables 1 and 2 differ in the following three points. First, Table 2 includes an additional column related to the engraving device at the right end compared to Table 1. Second, Table 2 includes a row showing “100” about the position on the metal foil after rolling compared to Table 1. Third, in Table 2, the pieces of information input to the cells in the area below the double line are rearranged based on the position on the metal foil compared to Table 1. Description will be given below. Tables 1 and 2 are the same except for the above points, and therefore redundant description will be omitted.

In Table 2, the cell at the right end of the top row shows “engraving device.” The cell immediately below the cell “engraving device” is left blank, and the cell below the blank cell shows “symbol.” In Table 2, information related to symbols engraved by the engraving device 50 is input to the area below the double line in the column added to the right end.

In Table 2, the area below the double line in the column added to the right end shows “B-100.” This indicates that the symbol “B-100” is engraved on the portion of the electrode 1 from “0” to “100” in terms of the positions on the metal foil after rolling. The symbols engraved on the electrode 1 are as described above, and therefore description will be omitted.

In Table 2, the pieces of information input to the cells in the area below the double line are rearranged based on the position on the metal foil. Description will be given of the row immediately below the double line as an example. In the row immediately below the double line, “0” is input to the cells related to the position on the metal foil. That is, the pieces of information related to the processing conditions in Table 1 are rearranged in terms of the position “0” on the metal foil. Similarly, the pieces of information related to the processing conditions in Table 1 are rearranged in terms of the positions “10,” “20,” “30,” . . . on the metal foil. Thus, the electrode 1 and the processing conditions can be stored in association with each other based on the reference position Re.

Returning to FIG. 12, a display process is performed next (S9). The control device 60 causes the display device 90 to display the Gantt chart GC. The Gantt chart GC is displayed with one axis showing the position on the electrode 1 or the metal foil 2 (distance Di from the reference position Re on the electrode 1) and the other axis showing the processing conditions for the electrode 1, etc. In the present embodiment, the Gantt chart GC is displayed with the horizontal axis showing the distance Di from the reference position Re and the vertical axis showing the processing conditions for the electrode 1, etc.

The items displayed on the vertical axis are not particularly limited, and can be selected as appropriate, as typified by the processing conditions for the electrode 1, the conditions of the processing device 30, the quality of the electrode 1 or the material of the electrode 1, and the inscriptions input via the input device 80. The processing conditions for the electrode 1 are not particularly limited. Examples thereof include information as to which of the coating materials 5 in the first container 31A to the third container 33A is applied, the temperatures of the coating materials 5 in the first container 31A to the third container 33A, the feeding speed of the metal foil 2, the ejection rate of the coating material 5, the pressure in the rolling device 30C, the temperature of the first pressing roll 31C, the temperature of the second pressing roll 32C, the temperature inside the drying device 30B, and the air speed in the drying device 30B.

The quality of the electrode 1 or the electrode sheet 4 is not particularly limited. Examples thereof include the thickness of the metal foil 2, the thickness of the active material layer 3, the charge voltage, the discharge voltage, and the capacity. Examples of the inscriptions include signs to distinguish the electrode sheets 4, lot numbers of the electrode sheets 4, and barcodes or QR codes (registered trademark) to distinguish the electrode sheets 4.

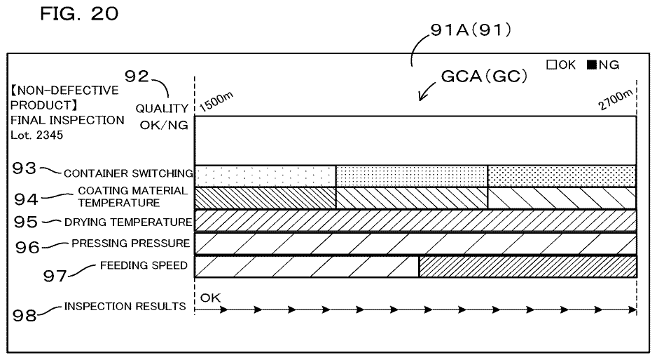

The display device 90 displays a display screen 91. FIG. 20 shows a first display screen 91A as an example of the display screen 91. The first display screen 91A displays a Gantt chart GCA with the horizontal axis showing the distance Di from the reference position Re. The first display screen 91A displays, at the upper right end, information indicating that a non-defective electrode 1 is displayed in white and a defective electrode 1 is displayed in black. The distinction between a non-defective product and a defective product is not limited to the display in white or black, and may be displayed in any color.

The distance Di from the reference position Re is displayed at a position near the top of the Gantt chart GCA. In the present embodiment, “1500 m” and “2700 m” are displayed. “1500 m” means that the left end of the Gantt chart GCA corresponds to a position at the distance “1500 m” from the reference position Re on the electrode 1. “2700 m” means that the right end of the Gantt chart GCA corresponds to a position at the distance “2700 m” from the reference position Re on the electrode 1. The Gantt chart GCA displays the area of the electrode 1 from “1500 m” to “2700 m” with respect to the reference position Re.

The quality of the electrode 1 is displayed in a portion 92 showing “quality” below the distance Di from the reference position Re. In the present embodiment, a white rectangle is displayed to indicate that the electrode 1 is a non-defective product. The product lot number of the electrode 1 is shown at the left of the portion 92 showing “quality.”

In a portion 93 showing “container switching” below the portion 92 showing “quality,” colored rectangles are displayed to indicate which of the coating materials 5 in the first container 31A to the third container 33A is applied. In the present embodiment, three different colors are shown to indicate that three types of coating material 5 are used. Which of the first container 31A to the third container 33A is used can be determined by the color of the rectangle.

In a portion 94 showing “coating material temperature” below “container switching,” colored rectangles are displayed to indicate the temperatures of the coating materials 5. In the present embodiment, three different colors are shown to indicate that the container temperatures are different in the first container 31A to the third container 33A. Specifically, the temperatures of the first container 31A to the third container 33A are displayed in different colors depending on whether the temperatures are higher or lower than a predetermined reference temperature. For example, the temperature higher than the reference temperature may be displayed in red, the temperature approximately equal to the reference temperature may be displayed in green, and the temperature lower than the reference temperature may be displayed in blue.

In a portion 95 showing “drying temperature” below “coating material temperature,” a rectangle is displayed to indicate the temperature inside the drying device 30B. In the present embodiment, the electrode sheets 4 are dried at a constant drying temperature.

In a portion 96 showing “pressing pressure” below “drying temperature,” a rectangle is displayed to indicate the pressure applied to the active material layer 3. In the present embodiment, the active material layer 3 is rolled at a constant pressure.

In a portion 97 showing “feeding speed” below “pressing pressure,” colored rectangles are displayed to indicate the feeding speeds of the metal foil 2. In the present embodiment, two different colors are shown to indicate that the feeding speed of the metal foil 2 is different between the first half and the second half of the manufacturing process. In the present embodiment, the metal foil 2 has two types of feeding speed for convenience of description, but the feeding speed of the metal foil 2 may be constant.

In a portion 98 showing “inspection results” below “feeding speed,” a plurality of arrows is displayed to indicate the inspection results for the electrode 1 or the electrode sheet 4. One arrow indicates a unit area where inspection is performed on the electrode 1 or the electrode sheet 4. In the present embodiment, the electrode 1 or the electrode sheets 4 has/have passed the inspection in all the unit areas.

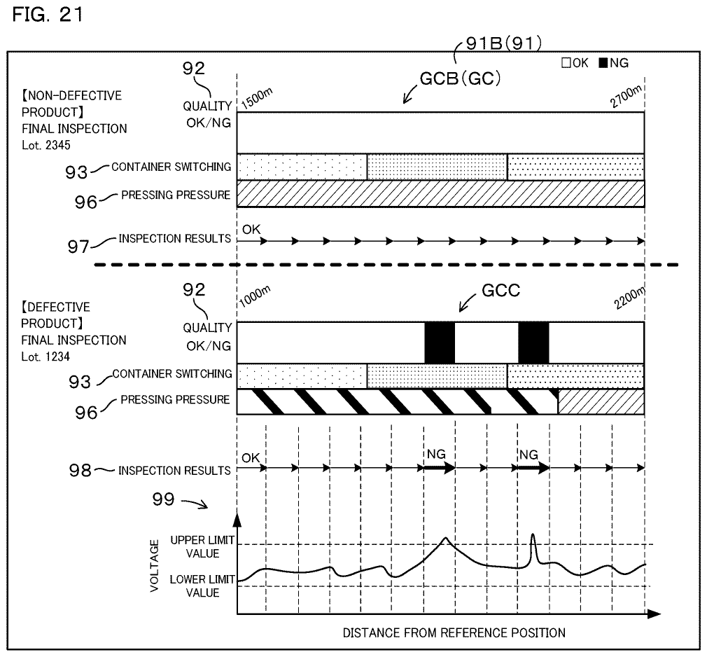

FIG. 21 shows a second display screen 91B as another example of the display screen 91. The second display screen 91B is intended to efficiently estimate the cause of a defect occurring in the electrode 1.

In the second display screen 91B, a Gantt chart GCB of the electrode 1 determined to be a non-defective product is displayed in the upper part, a Gantt chart GCC of the electrode 1 determined to be a defective product is displayed in the middle part, and a graph 99 showing a relationship between the voltage of the electrode 1 determined to be a defective product and the distance Di from the reference position Re is displayed in the lower part.

The vertical axes of the Gantt charts GCB, GCC displayed in the upper and middle parts show “quality,” “container switching,” “pressing pressure,” and “inspection results.” The present embodiment is an example in which no other items are selected.

First, description will be given of the Gantt chart GCC displayed in the middle part of FIG. 21 and showing a product determined to be a defective product. In the Gantt chart GCC of the defective product, the left end corresponds to a position at a distance “1000 m” from the reference position Re, and the right end corresponds to a position at a distance “2200 m” from the reference position Re. In the Gantt chart GCC of the defective product, the rectangles indicating “quality” are displayed in two different colors. The white rectangle indicates a non-defective portion, and the black rectangle indicates a defective portion. In the Gantt chart GCC of the product determined to be the defective product, the rectangles indicating “container switching” are displayed in three different colors (e.g., red, blue, and yellow). FIG. 21 shows three different patterns. The present embodiment is an example in which the coating materials 5 prepared in three different containers are used. In the Gantt chart GCC of the product determined to be the defective product, the rectangles indicating “pressing pressure” are displayed in two different colors (e.g., red and blue). That is, the present embodiment is an example in which the active material layer 3 is rolled at two different pressures.

Arrows indicating “inspection results” and corresponding to the black rectangles in the portion showing “quality” are wider than the others. This indicates that the inspection result of the electrode 1 or the electrode sheet 4 is “unacceptable” in the areas indicated by the wide arrows.

The vertical axis of the graph 99 shown in the lower part of the second display screen 91B shows the voltage of the electrode 1. The voltage may be either of the charge voltage or the discharge voltage. The vertical axis shows a lower limit value and an upper limit value greater than the lower limit value. The voltage between the lower limit value and the upper limit value is a voltage at which the electrode 1 or the electrode sheet 4 is determined to pass the inspection. In the present embodiment, the areas corresponding to the wide arrows in the portion 98 showing “inspection results” indicate the voltage value exceeding the upper limit value. By comparing the “quality” of the electrode 1 or the electrode sheet 4, the “inspection results” of the electrode 1 or the electrode sheet 4, and the specific physical properties (e.g., voltage), it is possible to easily identify the reason why the electrode 1 or the electrode sheet 4 is determined to be the “defective product.”

The second display screen 91B further displays the Gantt chart GCB of a product evaluated as a non-defective product as shown in the upper part of the second display screen 91B. As understood from the fact that the lot numbers of the products are different between the Gantt chart GCB of the non-defective product and the Gantt chart GCC of the defective product, the non-defective product is different from the electrode 1 evaluated as the defective product.

In the Gantt chart GCB of the non-defective product, the left end corresponds to a position at a distance “1500 m” from the reference position Re, and the right end corresponds to a position at a distance “2700 m” from the reference position Re.

In the Gantt chart GCB of the non-defective product, the processing condition selected in the portion 93 showing “container switching” is similar to that in the Gantt chart GCC of the defective product. That is, three containers are used to prepare the coating materials 5. With the second display screen 91B, the Gantt chart GCC of the defective product can be compared to the Gantt chart GCB of the non-defective product related to the processing condition similar to that of the defective product. Thus, it is possible to more easily identify the reason why the electrode 1 or the electrode sheet 4 is determined to be the “defective product.” In the present embodiment, the “pressing pressure” in the “non-defective product” and the “pressing pressure” in the “defective product” are different. Therefore, it is possible to presume that the cause may be the “pressing pressure.”

FIG. 23 shows a third display screen 91C as another example of the display screen 91. The third display screen 91C is an example in which the inscription 53 showing “B-300” is input to the input device 80.

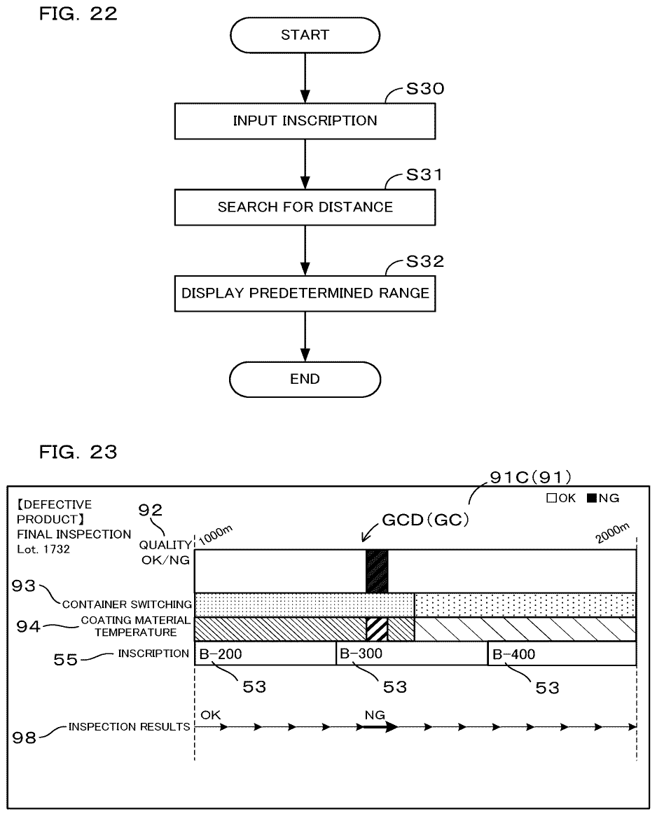

FIG. 22 is a flowchart when information related to the inscription 53 is input to the input device 80. When the inscription 53 showing “B-300” is input (S30), the control device 60 searches for the distance Di from the reference position Re that corresponds to the inscription 53 showing “B-300” (S31). The control device 60 extracts a predetermined area including the reference position Re corresponding to the inscription 53 showing “B-300.” The predetermined area is not particularly limited, and may be a range of the predetermined distance Di across the reference position Re corresponding to the inscription 53 showing “B-300,” or may be areas with inscriptions 53 before and after the inscription 53 showing “B-300” (i.e., an area with the inscription 53 showing “B-2000” and an area with the inscription 53 showing “B-200”). In the present embodiment, the area with the inscription 53 showing “B-200” and the area with the inscription 53 showing “B-400” are extracted across the inscription 53 showing “B-300.”

The control device 60 causes the display device 90 to display a Gantt chart GCD of the area with the inscription 53 showing “B-200,” the area with the inscription 53 showing “B-300,” and the area with the inscription 53 showing “B-400” in a portion 55 showing “inscription” in the third display screen 91C (S32). Accordingly, the process when information related to the inscription 53 is input to the input device 80 is completed.

As shown in FIG. 23, the third display screen 91C of the present embodiment displays a black portion determined to be “defective” in the portion 92 showing “quality.” In the present embodiment, the portion showing “container switching” is displayed in two different colors. That is, in the present embodiment, two types of coating material 5 are used.

Rectangles indicating “coating material temperature” are displayed below “container switching.” In the present embodiment, the temperature of the coating material 5 is different from the other temperatures at the position corresponding to the portion determined to be “defective” in terms of “quality.”

According to the present embodiment, it is possible to easily search for the defective portion of the electrode 1 or the electrode sheet 4. By comparing data in the predetermined area including the defective portion, the cause of the defect can be presumed easily.

Returning to FIG. 12, when the display process (S9) is completed, the operation of the electrode manufacturing apparatus 10 is ended.

### 6. Functions and Effects of Embodiment

According to the present embodiment, the processing conditions acquired from the control device 60 for the electrode 1 can be stored in association with the reference position Re on the metal foil 2 acquired from the first reference position detection device 22A and the second reference position detection device 22B, and the distance Di from the reference position Re on the metal foil 2 calculated based on the feeding amount of the metal foil 2 acquired from the feeding amount detection device 21. Thus, it is possible to store the electrode 1 manufactured by processing in association with the plurality of different processing conditions in the electrode manufacturing apparatus 10 that processes the metal foil 2 while changing the processing conditions over time. As a result, it is possible to clearly grasp the association between the portion where a defect has occurred in the electrode 1 and the processing conditions, thereby improving the level of the quality control of the electrode 1. In particular, the level of traceability of the electrode 1 can be improved.

According to the present embodiment, it is possible to easily find the relationship between the processing conditions and the occurrence of a defect by displaying the Gantt chart GC with the horizontal axis showing the distance Di from the reference position Re and the vertical axis showing the plurality of processing conditions. Thus, the defect occurrence rate can be reduced.

### Second Embodiment

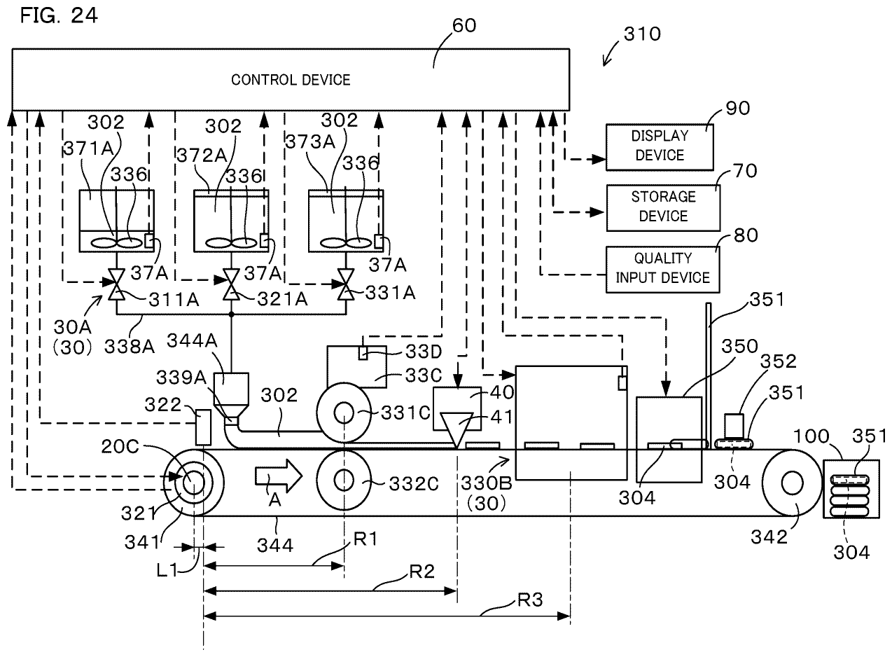

Next, a second embodiment in which the present disclosure is applied to a food production apparatus 310 will be described with reference to FIG. 24. In the food production apparatus 310 of the present embodiment, a belt conveyor 344 is laid between a first transport roll 341 and a second transport roll 342. A feeding amount detection device 321 is attached to the first transport roll 341.

Grain flour such as wheat flour or rice flour, liquid such as water or oil, and additives such as seasonings are charged into a first container 371 A to a third container 373A and kneaded by screws 336 to produce dough 302.

The dough 302 is transported to a nozzle 334A through a line 338A. The dough 302 flows down from a nozzle opening 339A of the nozzle 334A onto the belt conveyor 344. A reference position detection device 322 that detects the reference position Re on the dough 302 is disposed at substantially the same position in the feeding direction A as that of the nozzle 334A. The term “substantially the same position” means that the nozzle 334A and the reference position detection device 322 are not disposed at the same position but are disposed close to each other such that they can be recognized as being located at substantially the same position. The dough 302 is transported in the feeding direction A by the belt conveyor 344.

Although detailed illustration is omitted, the reference position Re serving as a reference for the starting point of the belt conveyor 344 is provided at a predetermined position on the belt conveyor 344. The reference position Re may be represented by letters, symbols, etc. printed on the front, side, or back surface of the belt conveyor 344, or may be a projection or a recess formed on the front, side, or back surface of the belt conveyor 344. Any form may be adopted.

The reference position Re cannot be engraved on the dough 302 according to the present embodiment. In the present embodiment, the reference position Re formed on the belt conveyor 344 is used. That is, the dough 302 flows down onto the belt conveyor 344 from the nozzle opening 339A of the nozzle 334A at the same time or substantially at the same time when the reference position detection device 322 detects the reference position Re on the belt conveyor 344. This can be achieved by disposing, at substantially the same position in the feeding direction A as that of the nozzle 334A, the reference position detection device 322 that detects the reference position Re on the dough 302.

The dough 302 transported by the belt conveyor 344 is rolled by a first pressing roll 331C and a second pressing roll 332C. The method for calculating and storing the distance Di from the reference position Re when the dough 302 is rolled is the same as in the first embodiment, and therefore redundant description will be omitted.

The rolled dough 302 is cut to a predetermined length dimension in the feeding direction A by the cutting device 40. The cutting device 40 transmits, to the control device 60, the position where the dough 302 is cut.

The cut dough 302 is heated by a heating device 330B at a predetermined temperature for a predetermined period. Thus, a food product 304 is completed. The heating method is not particularly limited, and any method can be selected as appropriate, as typified by heating with a heater, heating with hot air, heating with hot water, or heating with oil. The cut dough 302 may be cooled by a cooling device.

The food product 304 is packaged in a packaging material 351 by a packaging device 350. The packaging material 351 is supplied to the packaging device 350 from the outside. An inscription 53 that is a manufacturing number is provided on the packaging material 351 by a manufacturing number providing device 352. The packaged food product 304 is housed in the housing device 100. By linking the manufacturing number and the position where the dough 302 is cut, the cutting position on the dough 302 can be determined from the manufacturing number. When the position on the dough 302 is linked to the processing conditions, the processing conditions for the dough 302 can be determined from the position on the dough 302.

The distance between the reference position detection device 322 and the central axis of the first transport roll 341 is L1. The reference position detection device 322 and each of the first pressing roll 331C and the second pressing roll 332C are disposed away from each other by the reference distance R1. The reference position detection device 322 and the cutting device 40 are disposed away from each other by the reference distance R2. The reference position detection device 322 and the heating device 330B are disposed away from each other by the reference distance R3. The distance Di from the reference position Re on the dough 302 may be stored in association with the distance LI and the reference distances R1 to R3.

In the food production apparatus 310 shown in FIG. 24, the dough 302 is, at the same time, rolled at a position away from the reference position detection device 322 by the reference distance R1, cut at a position away from the reference position detection device 322 by the reference distance R2, and heated at a position away from the reference position detection device 322 by the reference distance R3. Description will be given from a different perspective. It is assumed that the dough 302 is ejected from the nozzle opening 339A at a certain time. A portion of the dough 302 that is ejected from the nozzle opening 339A at the certain time is provisionally referred to as a specific portion. When the specific portion is rolled by feeding it by the reference distance R1, cut by feeding it by the reference distance R2, and heated by feeding it by the reference distance R3, the rolling, cutting, and heating are performed at the same position, namely the specific portion of the dough 302.

The configuration other than that described above is substantially the same as in the first embodiment. Therefore, the same components are denoted by the same reference signs and redundant description will be omitted.

According to the present embodiment, in the food production apparatus 310, when the long dough 302 is processed while changing the conditions over time, the processing conditions changed over time are stored in association with specific position information on the dough 302. Thus, it is possible to centrally manage the rolling, cutting, and heating conditions for the same position, namely the specific portion of the dough 302.

### Third Embodiment

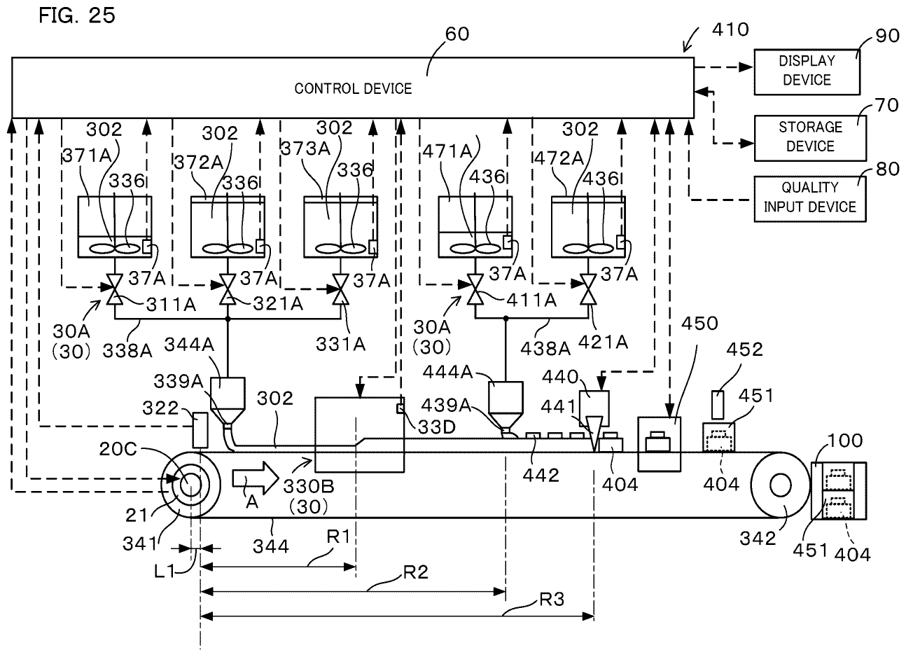

Next, a third embodiment in which the present disclosure is applied to a food production apparatus 410 will be described with reference to FIG. 25. In the present embodiment, the dough 302 that flows down onto the belt conveyor 344 is heated by the heating device 330B. The dough 302 expands by being heated in the heating device 330B.

Next, a topping material 442 such as jam or cream is poured onto the heated and expanded dough 302 from a nozzle opening 439A of a nozzle 444A.

The topping material 442 is produced by charging a sweetener such as sugar and a thickener such as starch or egg white into a fourth container 471A and a fifth container 472A and kneading them with screws 436. The topping material is transported to the nozzle 444A through a line 438A.

After the topping material 442 is put, the dough 302 is cut to a predetermined length dimension by a cutting device 440 including a cutter 441. Thus, a food product 404 is completed. The food product 404 is packaged in a packaging material 451 by a packaging device 450. An inscription 53 that is an engraved manufacturing number is provided on the packaging material 451 by a manufacturing number providing device 452. The packaged food product 404 is housed in the housing device 100.

The distance between the reference position detection device 322 and the central axis of the first transport roll 341 is L1. The reference position detection device 322 and the heating device 330B are disposed away from each other by the reference distance R1. The reference position detection device 322 and the nozzle 444A are disposed away from each other by the reference distance R2. The reference position detection device 322 and the cutting device 440 are disposed away from each other by the reference distance R3. The distance Di from the reference position Re on the dough 302 may be stored in association with the distance LI and the reference distances R1 to R3.

The configuration other than that described above is substantially the same as in the second embodiment. Therefore, the same components are denoted by the same reference signs and redundant description will be omitted.

According to the present embodiment, even when the process of heating the dough 302, topping the dough 302 with the topping material 442, and then cutting the dough 302 is performed, the food product 404 produced by processing can be stored in association with the processing conditions.

The present disclosure is not limited to the above embodiments, and can be applied to, for example, the following forms without departing from the spirit of the present disclosure.

The storage device stores the processing conditions acquired from the control device for a long product manufactured by processing performed by the processing device in association with the feeding amount from the reference position that is acquired from the feeding amount detection device for each elapsed period.

The long object processing apparatus includes a feeding device, a processing device, a control device, a reference position detection device, a feeding amount detection device, and a storage device. The feeding device feeds a long material in a feeding direction. The processing device processes the long material fed by the feeding device. The control device controls operations of the feeding device and the processing device, causes the processing device to continuously process the long material in the feeding direction, and causes the processing device to process the long material while changing a plurality of different processing conditions over time during continuous processing. The reference position detection device detects a reference position near a starting end of the long material. The feeding amount detection device detects a feeding amount of the long material in the feeding direction. The storage device stores the processing conditions acquired from the control device for a long product manufactured by processing performed by the processing device in association with the reference position on the long material that is acquired from the reference position detection device and a distance from the reference position on the long material that is calculated based on the feeding amount of the long material that is acquired from the feeding amount detection device. IN THE CLAIMS Please amend the claims as follows:

1-9. (canceled)

10. A long object processing apparatus comprising:
a feeding device or a belt conveyor that feeds a long material in a feeding direction;
a processing device that processes the long material fed by the feeding device or the belt conveyor;
a control device that controls operations of the feeding device or the belt conveyor and the processing device, causes the processing device to continuously process the long material in the feeding direction, and causes the processing device to process the long material while changing a plurality of different processing conditions over time during continuous processing;
a reference position detection device that detects a reference position that is a reference for the long material or a reference for a starting point of the belt conveyor;
a feeding amount detection device that detects a feeding amount of the long material from the reference position in the feeding direction in terms of a unit period or in terms of a unit feeding amount; and
a storage device that stores the processing conditions acquired from the control device for a long product manufactured by processing performed by the processing device in association with the feeding amount from the reference position that is acquired from the feeding amount detection device in terms of the unit period or in terms of the unit feeding amount, wherein:
the processing device is a coating device that applies a coating material to the long material as processing of the long material;
the processing device includes a plurality of containers that contains the coating material, and forms a composite layer on a metal foil while switching the plurality of containers;
the processing conditions are related to which container out of the plurality of containers contains the applied coating material; and
the storage device stores information as to which container out of the plurality of containers contains the applied coating material in association with the feeding amount from the reference position that is acquired from the feeding amount detection device.

11. The long object processing apparatus according to claim 10, wherein:
a plurality of the processing devices is provided;
the processing conditions are set for each of the plurality of the processing devices;
a reference distance that is a distance between the reference position and each of the plurality of the processing devices is set for each of the plurality of the processing devices;
the storage device stores the reference distance for each of the plurality of the processing devices; and
the control device converts the processing conditions stored in the storage device in association with the feeding amount from the reference position that is acquired from the feeding amount detection device in terms of the unit period or in terms of the unit feeding amount into processing conditions associated with each position on the long material by subtracting the reference distance from the feeding amount, and causes the storage device to store the converted processing conditions.

12. The long object processing apparatus according to claim 11, further comprising a display device that displays a Gantt chart with one axis showing a position on the long material and the other axis showing at least the processing conditions.

13. The long object processing apparatus according to claim 10, further comprising:
a cutting device that cuts the long product to a predetermined length dimension; and
a manufacturing number providing device that provides a manufacturing number to the long product or a packaging material that packages the long product, wherein the storage device stores, for a cut object cut out by the cutting device, the feeding amount from the reference position in a state of the long product before the cut object is cut out in association with the manufacturing number.

14. The long object processing apparatus according to claim 13, further comprising a quality input device to which quality of the cut object is input, wherein the storage device stores the quality of the cut object that is acquired via the quality input device in association with the feeding amount from the reference position.

15. The long object processing apparatus according to claim 10, further comprising a sensor that measures a state of the processing device, wherein the storage device stores the state of the processing device that is acquired via the sensor in association with the feeding amount from the reference position that is acquired from the feeding amount detection device in terms of the unit period or in terms of the unit feeding amount.

16. The long object processing apparatus according to claim 10, further comprising a quality input device to which quality of the long product is input, wherein the storage device stores the quality of the long product that is acquired via the quality input device in association with the feeding amount from the reference position that is acquired from the feeding amount detection device.

17. The long object processing apparatus according to claim 10, wherein:
the processing device is a rolling device that rolls the long material as processing of the long material;
a post-rolling feeding amount detection device is further provided to detect a post-rolling feeding amount of the rolled long material from the reference position in the feeding direction; and
the storage device stores the feeding amount of the long material from the reference position in a state before rolling in association with the post-rolling feeding amount that is the feeding amount of the long material from the reference position in a state after rolling.

18. A long object processing apparatus comprising:
a feeding device or a belt conveyor that feeds a long material in a feeding direction;
a processing device that processes the long material fed by the feeding device or the belt conveyor;
a control device that controls operations of the feeding device or the belt conveyor and the processing device, causes the processing device to continuously process the long material in the feeding direction, and causes the processing device to process the long material while changing a plurality of different processing conditions over time during continuous processing;
a reference position detection device that detects a reference position that is a reference for the long material or a reference for a starting point of the belt conveyor;
a feeding amount detection device that detects a feeding amount of the long material from the reference position in the feeding direction in terms of a unit period or in terms of a unit feeding amount; and
a storage device that stores the processing conditions acquired from the control device for a long product manufactured by processing performed by the processing device in association with the feeding amount from the reference position that is acquired from the feeding amount detection device in terms of the unit period or in terms of the unit feeding amount, wherein:
a plurality of the processing devices is provided;
the processing conditions are set for each of the plurality of the processing devices;
a reference distance that is a distance between the reference position and each of the plurality of the processing devices is set for each of the plurality of the processing devices;
the storage device stores the reference distance for each of the plurality of the processing devices; and
the control device converts the processing conditions stored in the storage device in association with the feeding amount from the reference position that is acquired from the feeding amount detection device in terms of the unit period or in terms of the unit feeding amount into processing conditions associated with each position on the long material by subtracting the reference distance from the feeding amount, and causes the storage device to store the converted processing conditions.

19. The long object processing apparatus according to claim 18, further comprising a display device that displays a Gantt chart with one axis showing a position on the long material and the other axis showing at least the processing conditions.

20. The long object processing apparatus according to claim 18, further comprising:
a cutting device that cuts the long product to a predetermined length dimension; and
a manufacturing number providing device that provides a manufacturing number to the long product or a packaging material that packages the long product, wherein the storage device stores, for a cut object cut out by the cutting device, the feeding amount from the reference position in a state of the long product before the cut object is cut out in association with the manufacturing number.

21. The long object processing apparatus according to claim 20, further comprising a quality input device to which quality of the cut object is input, wherein the storage device stores the quality of the cut object that is acquired via the quality input device in association with the feeding amount from the reference position.

22. The long object processing apparatus according to claim 18, further comprising a sensor that measures a state of the processing device, wherein the storage device stores the state of the processing device that is acquired via the sensor in association with the feeding amount from the reference position that is acquired from the feeding amount detection device in terms of the unit period or in terms of the unit feeding amount.

23. The long object processing apparatus according to claim 18, further comprising a quality input device to which quality of the long product is input, wherein the storage device stores the quality of the long product that is acquired via the quality input device in association with the feeding amount from the reference position that is acquired from the feeding amount detection device.

24. The long object processing apparatus according to claim 18, wherein:
the processing device is a rolling device that rolls the long material as processing of the long material;
a post-rolling feeding amount detection device is further provided to detect a post-rolling feeding amount of the rolled long material from the reference position in the feeding direction; and
the storage device stores the feeding amount of the long material from the reference position in a state before rolling in association with the post-rolling feeding amount that is the feeding amount of the long material from the reference position in a state after rolling.

25. A long object processing apparatus comprising:
a feeding device or a belt conveyor that feeds a long material in a feeding direction;
a processing device that processes the long material fed by the feeding device or the belt conveyor;
a control device that controls operations of the feeding device or the belt conveyor and the processing device, causes the processing device to continuously process the long material in the feeding direction, and causes the processing device to process the long material while changing a plurality of different processing conditions over time during continuous processing;
a reference position detection device that detects a reference position that is a reference for the long material or a reference for a starting point of the belt conveyor;
a feeding amount detection device that detects a feeding amount of the long material from the reference position in the feeding direction in terms of a unit period or in terms of a unit feeding amount;
a storage device that stores the processing conditions acquired from the control device for a long product manufactured by processing performed by the processing device in association with the feeding amount from the reference position that is acquired from the feeding amount detection device in terms of the unit period or in terms of the unit feeding amount;
a cutting device that cuts the long product to a predetermined length dimension; and
a manufacturing number providing device that provides a manufacturing number to the long product or a packaging material that packages the long product, wherein the storage device stores, for a cut object cut out by the cutting device, the feeding amount from the reference position in a state of the long product before the cut object is cut out in association with the manufacturing number.

26. The long object processing apparatus according to claim 25, further comprising a quality input device to which quality of the cut object is input, wherein the storage device stores the quality of the cut object that is acquired via the quality input device in association with the feeding amount from the reference position.

27. The long object processing apparatus according to claim 25, further comprising a sensor that measures a state of the processing device, wherein the storage device stores the state of the processing device that is acquired via the sensor in association with the feeding amount from the reference position that is acquired from the feeding amount detection device in terms of the unit period or in terms of the unit feeding amount.

28. The long object processing apparatus according to claim 25, further comprising a quality input device to which quality of the long product is input, wherein the storage device stores the quality of the long product that is acquired via the quality input device in association with the feeding amount from the reference position that is acquired from the feeding amount detection device.

29. The long object processing apparatus according to claim 25, wherein:
the processing device is a rolling device that rolls the long material as processing of the long material;
a post-rolling feeding amount detection device is further provided to detect a post-rolling feeding amount of the rolled long material from the reference position in the feeding direction; and
the storage device stores the feeding amount of the long material from the reference position in a state before rolling in association with the post-rolling feeding amount that is the feeding amount of the long material from the reference position in a state after rolling.
